(19) United States
(12) Patent Application Publication
(10) Pub. No.: US 2024/0153317 A1
(43) Pub. Date: May 9, 2024

(54) MANAGEMENT DEVICE, MANAGEMENT SYSTEM, METHOD, AND RECORDING MEDIUM

(71) Applicant: NEC Corporation, Minato-ku, Tokyo (JP)

(72) Inventor: Yoshio INOUE, Tokyo (JP)

(73) Assignee: NEC Corporation, Minato-ku, Tokyo (JP)

(21) Appl. No.: 18/280,086

(22) PCT Filed: Mar. 10, 2021
(86) PCT No.: PCT/JP2021/009423

§ 371 Date: Sep. 1, 2023

(51) Int. Cl. G07B 15/02; G06F 21/32; G06Q 10/02; G06Q 30/0207; G06V 20/56; G06V 40/10

(52) U.S. Cl. CPC G07B 15/02; G06F 21/32; G06Q 10/02; G06Q 30/0207; G06V 20/56; G06V 40/10

(57) ABSTRACT

In order to more improve a level of satisfaction of a passenger in transportation including a plurality of vehicles, a management apparatus (100A) includes: a detecting section (13A) which detects a passenger in a vicinity of a doorway of at least any vehicle included in a plurality of vehicles; an obtaining section (11A) which obtains (i) information indicative of an attribute of the passenger who has been detected by the detecting section (13A) and (ii) information indicative of an attribute of the at least any vehicle having the doorway in which the passenger has been detected; and a setting section (12A) which sets a fare to be collected from the passenger, in accordance with a combination of the attribute of the passenger and the attribute of the at least any vehicle.

### TECHNICAL FIELD

The present invention relates to a technique of managing boarding and alighting in transportation.

### BACKGROUND ART

A technique for managing boarding and alighting in transportation is known. For example, Patent Literature 1 discloses a technique in which a vehicle-mounted system that is mounted on a vehicle reads biometric information relating to a passenger at a time of acceptance of boarding, and carries out fare adjustment at a time of determination of a section used, with reference to an effective section associated with biometric information registered in advance.

### CITATION LIST

### Patent Literature

[Patent Literature 1]
Japanese Patent Application Publication Tokukaihei No. 2018-92388

### SUMMARY OF INVENTION

### Technical Problem

In transportation including a plurality of vehicles, it is possible that comfort varies depending on the vehicles because, for example, a specific vehicle is congested due to convenience such as the fact that the vehicle provides a good transit or the fact that the vehicle is close to a ticket gate. However, in the technique disclosed in Patent Literature 1, the fare adjustment is carried out regardless of comfort. Therefore, there is a problem that a passenger may feel unfairness.

An example aspect of the present invention has been made in view of the above problem, and an example object thereof is to provide a technique for further improving a level of satisfaction of a passenger in transportation including a plurality of vehicles.

### Solution to Problem

A management apparatus in accordance with an aspect of the present invention is a management apparatus including: a detecting means for detecting a passenger in a vicinity of a doorway of at least any vehicle included in a plurality of vehicles; an obtaining means for obtaining (i) information indicative of an attribute of the passenger who has been detected by the detecting means and (ii) information indicative of an attribute of the at least any vehicle having the doorway in which the passenger has been detected; and a setting means for setting a fare to be collected from the passenger, in accordance with a combination of the attribute of the passenger and the attribute of the at least any vehicle.

A management apparatus in accordance with an aspect of the present invention is a management apparatus including: a setting means for setting a fare to be collected from a passenger, in accordance with a combination of an attribute of the passenger and an attribute of a vehicle which is included in a plurality of vehicles and which is to be used by the passenger; a storage means for storing therein reservation information including information indicative of the attribute of the vehicle to be used by the passenger; a detecting means for detecting the passenger in a vicinity of a doorway of at least any vehicle included in the plurality of vehicles; an obtaining means for obtaining information indicative of an attribute of the at least any vehicle having the doorway in which the passenger has been detected; and a determining means for determining whether or not the information which is indicative of the attribute of the at least any vehicle and which has been obtained by the obtaining means matches the information which is indicative of the attribute of the vehicle and which is included in the reservation information.

A management system in accordance with an aspect of the present invention is a management system including: the management apparatus described above; and a detection apparatus which is provided in the vicinity of the doorway of the at least any vehicle included in the plurality of vehicles and which detects the passenger, the detecting means detecting the passenger with use of the detection apparatus.

A method in accordance with an aspect of the present invention is a method including: detecting a passenger in a vicinity of a doorway of at least any vehicle included in a plurality of vehicles; obtaining (i) information indicative of an attribute of the passenger who has been detected and (ii) information indicative of an attribute of the at least any vehicle having the doorway in which the passenger has been detected; and setting a fare to be collected from the passenger, in accordance with a combination of the attribute of the passenger and the attribute of the at least any vehicle.

A method in accordance with an aspect of the present invention is a method including: setting a fare to be collected from a passenger, in accordance with a combination of an attribute of the passenger and an attribute of a vehicle which is included in a plurality of vehicles and which is to be used by the passenger; storing reservation information including information indicative of the attribute of the vehicle to be used by the passenger; detecting the passenger in a vicinity of a doorway of at least any vehicle included in the plurality of vehicles; obtaining information indicative of an attribute of the at least any vehicle having the doorway in which the passenger has been detected; and determining whether or not the information which is indicative of the attribute of the at least any vehicle having the doorway in which the passenger has been detected matches the information which is indicative of the attribute of the vehicle and which is included in the reservation information.

A program in accordance with an aspect of the present invention is a program for causing a computer to function as a management apparatus, the program causing the computer to function as: a detecting means for detecting a passenger in a vicinity of a doorway of at least any vehicle included in a plurality of vehicles; an obtaining means for obtaining (i) information indicative of an attribute of the passenger who has been detected by the detecting means and (ii) information indicative of an attribute of the at least any vehicle having the doorway in which the passenger has been detected; and a setting means for setting a fare to be collected from the passenger, in accordance with a combination of the attribute of the passenger and the attribute of the at least any vehicle.

A program in accordance with an aspect of the present invention is a program for causing a computer to function as a management apparatus, the program causing the computer to function as: a setting means for setting a fare to be collected from a passenger, in accordance with a combination of an attribute of the passenger and an attribute of a vehicle which is included in a plurality of vehicles and which is to be used by the passenger; a storage means for storing therein reservation information including information indicative of the attribute of the vehicle to be used by the passenger; a detecting means for detecting the passenger in a vicinity of a doorway of at least any vehicle included in the plurality of vehicles; an obtaining means for obtaining information indicative of an attribute of the at least any vehicle having the doorway in which the passenger has been detected; and a determining means for determining whether or not the information which is indicative of the attribute of the at least any vehicle and which has been obtained by the obtaining means matches the information which is indicative of the attribute of the vehicle and which is included in the reservation information.

### Advantageous Effects of Invention

According to an example aspect of the present invention, it is possible to further improve a level of satisfaction of a passenger in transportation including a plurality of vehicles.

### BRIEF DESCRIPTION OF DRAWINGS

FIG. 1 is a block diagram illustrating a configuration of a management system in accordance with a first example embodiment of the present invention.

FIG. 2 is a flowchart illustrating a flow of a management method in accordance with the first example embodiment of the present invention.

FIG. 3 is a block diagram illustrating a configuration of a management system in accordance with a second example embodiment of the present invention.

FIG. 4 is a flowchart illustrating a flow of a management method in accordance with the second example embodiment of the present invention.

FIG. 5 is a block diagram illustrating a configuration of a management system in accordance with a third example embodiment of the present invention.

FIG. 6 is a block diagram illustrating a configuration of a vehicle-mounted apparatus in accordance with the third example embodiment of the present invention.

FIG. 7 is a drawing illustrating an example of fare setting information in the third example embodiment of the present invention.

FIG. 8 is a block diagram illustrating a configuration of an IC tag in the third example embodiment of the present invention.

FIG. 9 is a flowchart illustrating a flow of a management method in accordance with the third example embodiment of the present invention.

FIG. 10 is a block diagram illustrating a configuration of a management system in accordance with a fourth example embodiment of the present invention.

FIG. 11 is a block diagram illustrating a configuration of a management server in accordance with the fourth example embodiment of the present invention.

FIG. 12 is a drawing illustrating an example of passenger information in the fourth example embodiment of the present invention.

FIG. 13 is a drawing illustrating an example of reservation information in the fourth example embodiment of the present invention.

FIG. 14 is a block diagram illustrating a configuration of a vehicle-mounted apparatus in accordance with the fourth example embodiment of the present invention.

FIG. 15 is a flowchart illustrating a flow of a reservation method in accordance with the fourth example embodiment of the present invention.

FIG. 16 is a flowchart illustrating a flow of a management method at a time of boarding in accordance with the fourth example embodiment of the present invention.

FIG. 17 is a flowchart illustrating a flow of a management method at a time of alighting in accordance with the fourth example embodiment of the present invention.

FIG. 18 is a block diagram illustrating a configuration of a management system in accordance with a fifth example embodiment of the present invention.

FIG. 19 is a block diagram illustrating a configuration of a management server in accordance with the fifth example embodiment of the present invention.

FIG. 20 is a drawing illustrating an example of a configuration of passenger information in the fifth example embodiment of the present invention.

FIG. 21 is a block diagram illustrating a configuration of a vehicle-mounted apparatus in accordance with the fifth example embodiment of the present invention.

FIG. 22 is a flowchart illustrating a flow of a reservation method in accordance with the fifth example embodiment of the present invention.

FIG. 23 is a flowchart illustrating a flow of a management method at a time of boarding in accordance with the fifth example embodiment of the present invention.

FIG. 24 is a flowchart illustrating a flow of a management method at a time of alighting in accordance with the fifth example embodiment of the present invention.

FIG. 25 is a flowchart illustrating a flow of a registration method in accordance with the fifth example embodiment of the present invention.

FIG. 26 is a flowchart illustrating a flow of a management method at a time of boarding and alighting in accordance with the fifth example embodiment of the present invention.

FIG. 27 is a block diagram illustrating an example of a hardware configuration of a control apparatus in each of the example embodiments of the present invention.

### DESCRIPTION OF EMBODIMENTS

### First Example Embodiment

A first example embodiment of the present invention is described in detail with reference to drawings.

<Configuration of Management System 1A>

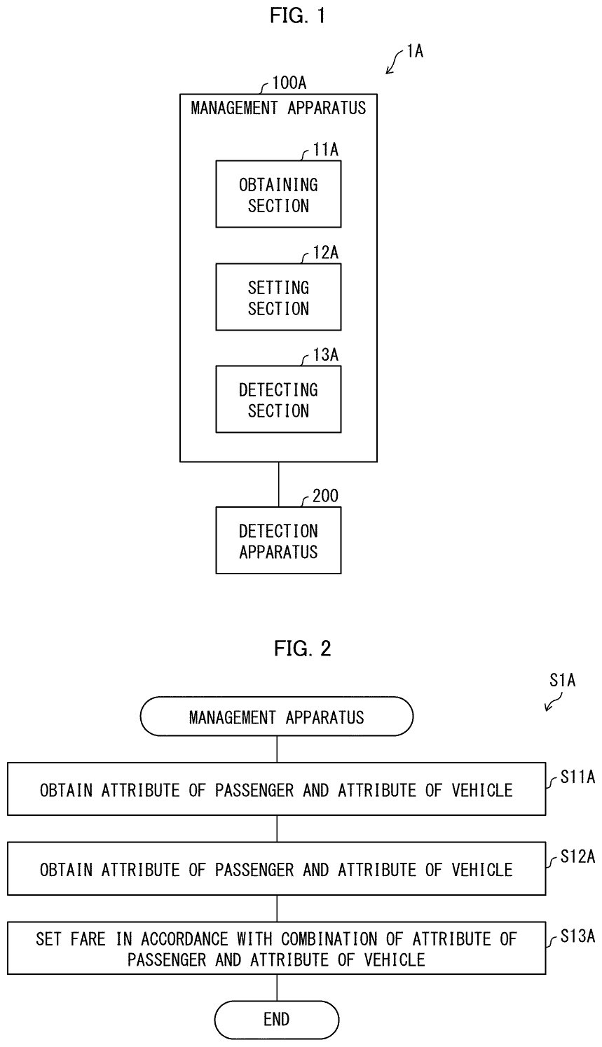

A configuration of a management system 1A in accordance with the present example embodiment is described with reference to FIG. 1. FIG. 1 is a block diagram illustrating the configuration of the management system 1A. As illustrated in FIG. 1, the management system 1A includes a management apparatus 100A and a detection apparatus 200. The management apparatus 100A includes an obtaining section 11A, a setting section 12A, and a detecting section 13A. The obtaining section 11A is an example of a configuration realizing an “obtaining means” recited in the claims. The setting section 12A is an example of a configuration realizing a “setting means” recited in the claims. The detecting section 13A is an example of a configuration realizing a “detecting means” recited in the claims. The management apparatus 100A and the detection apparatus 200 are communicably connected to each other.

The detecting section 13A detects a passenger in a vicinity of a doorway of at least any vehicle included in a plurality of vehicles, with use of the detection apparatus 200.

The detection apparatus 200 is an apparatus which detects a passenger. The detection apparatus 200 is provided in the vicinity of the doorway of the at least any vehicle included in the plurality of vehicles.

The obtaining section 11A obtains (i) information indicative of an attribute of the passenger who has been detected by the detecting section 13A and (ii) information indicative of an attribute of the vehicle having the doorway in which the passenger has been detected. Examples of the attribute of the passenger include, but are not limited to, his/her age and presence or absence of a companion. Examples of the attribute of the vehicle include, but are not limited to, assumed passenger brackets and types of company advertisements.

The setting section 12A sets a fare to be collected from the passenger, in accordance with a combination of the attribute of the passenger and the attribute of the vehicle.

<Flow of Management Method S1A>

A flow of a management method S1A carried out by the management system 1A configured as described above is described with reference to FIG. 2. FIG. 2 is a flowchart illustrating the flow of the management method S1A. As illustrated in FIG. 2, the management method S1A includes steps S11A to S13A.

(Step S11A)

In the step S11A, the detecting section 13A detects a passenger in a vicinity of a doorway of any vehicle, with reference to information received from the detection apparatus 200. For example, in a case where the detection apparatus 200 is a camera, the detecting section 13A may detect the passenger by receiving, from the detection apparatus 200, an image including the passenger as a subject. Alternatively, for example, in a case where the detection apparatus 200 is an integrated circuit (IC) tag reader, the detecting section 13A may detect the passenger carrying an IC tag, by receiving, from the detection apparatus 200, information which has been read from the IC tag.

(Step S12A)

In the step S12A, the obtaining section 11A of the management apparatus 100A obtains (i) information indicative of an attribute of the passenger who has been detected and (ii) information indicative of an attribute of the vehicle having the doorway in which the passenger has been detected. For example, in a case where the detecting section 13A has received the image including the passenger as a subject, the obtaining section 11A may obtain the attribute of the passenger by analyzing the image and then estimating the attribute of the passenger. Alternatively, for example, in a case where the detecting section 13A has received the information which has been read by the IC tag reader, the obtaining section 11A may obtain the information which is indicative of the attribute of the passenger and which is included in the information. Further, for example, the obtaining section 11A may store, in a memory (not illustrated) in advance, the information indicative of the attribute of the vehicle to which the detection apparatus 200 is provided, and obtain the information by reading the information from the memory.

(Step S13A)

In the step S13A, the setting section 12A sets a fare to be collected from the passenger, in accordance with a combination of the attribute of the passenger and the attribute of the vehicle. For example, the setting section 12A may store, in the memory, a rule under which the fare is calculated with use of the attribute of the passenger and the attribute of the vehicle, and sets the fare with use of the rule.

### Effects of the Present Example Embodiment

In the present example embodiment, a fare is set in accordance with a combination of an attribute of a passenger and an attribute of a vehicle which is included in a plurality of vehicles and which the passenger has actually boarded. Therefore, a level of satisfaction of the passenger is improved. Reasons for this are described.

Comfort which a passenger feels when the passenger boards any of a plurality of vehicles can vary depending on an attribute of the passenger and an attribute of the vehicle which the passenger boards. For example, a passenger having an attribute “with a child” often feels more comfortable when the passenger boards a vehicle having an attribute “for family” than when the passenger boards a vehicle having an attribute “for commute”. For example, a passenger having an attribute “general” often feels more comfortable when the passenger boards a vehicle having an attribute “for commute” than when the passenger boards a vehicle having an attribute “for family”. Therefore, in the present example embodiment, a passenger pays a fare which corresponds to comfort that the passenger feels in a vehicle that the passenger actually boards. Therefore, a level of satisfaction of the passenger is improved as compared with a case where a fare does not vary regardless of comfort even in a case where the passenger boards any vehicle.

### Second Example Embodiment

A second example embodiment of the present invention is described in detail with reference to drawings.

<Configuration of Management System 1B>

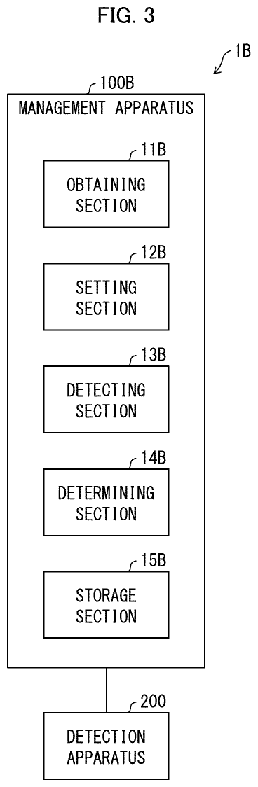

A configuration of a management system 1B in accordance with the present example embodiment is described with reference to FIG. 3. FIG. 3 is a block diagram illustrating the configuration of the management system 1B. As illustrated in FIG. 3, the management system 1B includes a management apparatus 100B and a detection apparatus 200. The management apparatus 100B includes an obtaining section 11B, a setting section 12B, a detecting section 13B, a determining section 14B, and a storage section 15B. The determining section 14B is an example of a configuration realizing a “determining means” recited in the claims. The storage section 15B is an example of a configuration realizing a “storage means” recited in the claims. A configuration of the detection apparatus 200 is as described in the first example embodiment.

The setting section 12B sets a fare to be collected from a passenger, in accordance with a combination of an attribute of the passenger and an attribute of a vehicle which is included in a plurality of vehicles and which is to be used by the passenger.

The storage section 15B stores therein reservation information including information indicative of the attribute of the vehicle to be used by the passenger.

The detecting section 13B detects the passenger relating to the reservation information, in a vicinity of a doorway of at least any vehicle included in the plurality of vehicles.

The obtaining section 11B obtains information indicative of an attribute of the vehicle having the doorway in which the passenger relating to the reservation information has been detected.

The determining section 14B determines whether or not the information which is indicative of the attribute of the vehicle and which has been obtained by the obtaining section 11B matches the information which is indicative of the attribute of the vehicle and which is included in the reservation information.

<Flow of Management Method S1B>

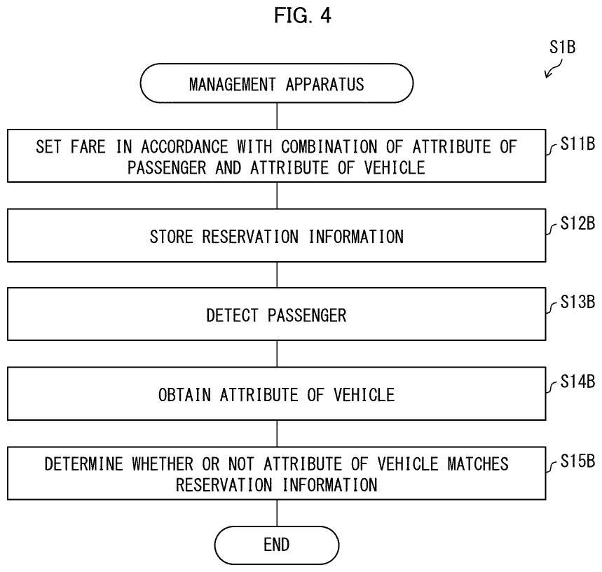

A flow of a management method S1B carried out by the management system 1B configured as described above is described with reference to FIG. 4. FIG. 4 is a flowchart illustrating the flow of the management method S1B. As illustrated in FIG. 4, the management method S1B includes steps S11B to S15B.

(Step S11B)

In the step S11B, the setting section 12B sets a fare to be collected from a passenger, in accordance with a combination of an attribute of the passenger and an attribute of a vehicle which is included in a plurality of vehicles and which is to be used by the passenger. For example, the setting section 12B may obtain information indicative of the attribute of the vehicle to be used and information indicative of the attribute of the passenger, on the basis of information inputted by the passenger or an operator via an input apparatus (not illustrated). Note that a detailed example of a process of setting the fare in accordance with the combination of the attribute of the passenger and the attribute of the vehicle, each of which attributes is indicated by the obtained information, is as described in the first example embodiment.

(Step S12B)

In the step S12B, the setting section 12B stores, in the storage section 15B, reservation information including the information indicative of the attribute of the vehicle to be used by the passenger. For example, the reservation information includes a passenger ID and the information indicative of the attribute of the vehicle to be used. The reservation information may further include a face image of the passenger.

(Step S13B)

In the step S13B, the detecting section 13B detects the passenger relating to the reservation information, in a vicinity of a doorway of any vehicle, with reference to information received from the detection apparatus 200. For example, the detecting section 13B may detect the passenger relating to the reservation information, by determining that a face image included in an image captured by the detection apparatus 200 and the face image included in the reservation information indicate an identical person. Alternatively, for example, the detecting section 13B may detect the passenger relating to the reservation information, by determining that a passenger ID included in information read from an IC tag and the passenger ID included in the reservation information match each other.

(Step S14B)

In the step S14B, the obtaining section 11B obtains information indicative of an attribute of the vehicle having the doorway in which the passenger relating to the reservation information has been detected. For example, the obtaining section 11B may store, in a memory (not illustrated) in advance, the information indicative of the attribute of the vehicle to which the detection apparatus 200 is provided, and obtain the information by reading the information from the memory.

(Step S15B)

In the step S15B, the determining section 14B determines whether or not the information which is indicative of the attribute of the vehicle and which has been obtained by the obtaining section 11B matches the information which is indicative of the attribute of the vehicle and which is included in the reservation information. For example, in a case where the determining section 14B determines that these pieces of information do not match, the determining section 14B may output this determination result to a display apparatus (not illustrated) provided in the vicinity of the doorway. Thus, the passenger can recognize that the passenger is to board the vehicle which differs from the reservation information.

### Effects of the Present Example Embodiment

In the present example embodiment, a fare is set which corresponds to a combination of an attribute of a passenger and an attribute of a vehicle which is included in a plurality of vehicles and which is to be used by the passenger. Therefore, a level of satisfaction of the passenger is improved. Reasons for this are described.

As described as the effects of the first example embodiment, comfort which a passenger feels when the passenger boards any of a plurality of vehicles can vary depending on an attribute of the passenger and an attribute of the vehicle which the passenger boards. By the passenger reserving a vehicle having a desired attribute in advance, a fare which corresponds to comfort is set. In addition, when the passenger actually boards a vehicle, it is determined whether or not an attribute of the vehicle which the passenger boards matches reservation information. Therefore, it can be more certainly expected that the passenger boards a vehicle having an attribute which matches the reservation information. As a result, a level of satisfaction of the passenger is improved as compared with a case where a fare does not vary regardless of comfort even in a case where the passenger boards any vehicle.

### Third Example Embodiment

A third example embodiment of the present invention is described in detail with reference to drawings. The present example embodiment is an embodiment which realizes setting of a fare that corresponds to an attribute of a passenger and an attribute of a vehicle, with use of an IC tag carried by the passenger and without the need of a reservation.

<Configuration of Management System 2>

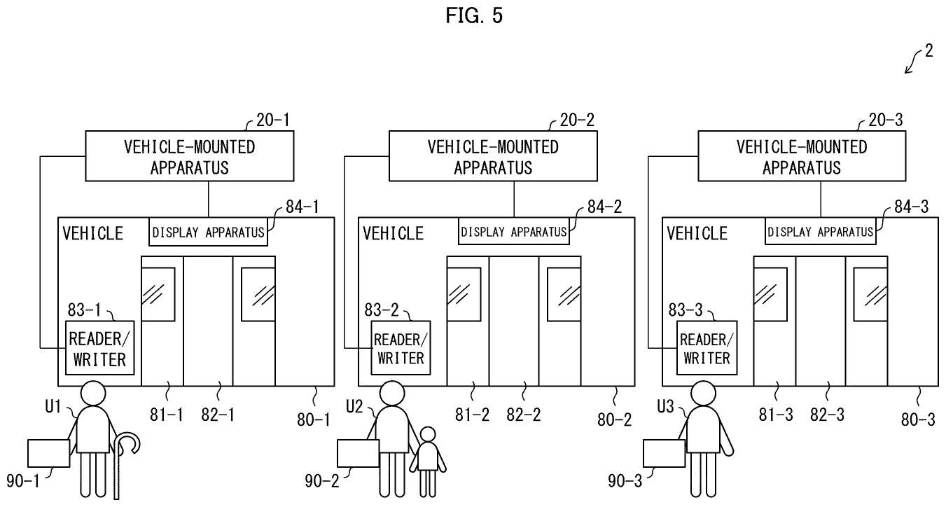

A configuration of a management system 2 in accordance with the present example embodiment is described with reference to FIG. 5. FIG. 5 is a block diagram illustrating the configuration of the management system 2. As illustrated in FIG. 5, the management system 2 includes vehicle-mounted apparatuses 20-1 to 20-3, reader/writers 83-1 to 83-3, and display apparatuses 84-1 to 84-3. The vehicle-mounted apparatus 20-1, the reader/writer 83-1, and the display apparatus 84-1 are provided to a vehicle 80-1. The vehicle-mounted apparatus 20-2, the reader/writer 83-2, and the display apparatus 84-2 are provided to a vehicle 80-2. The vehicle-mounted apparatus 20-3, the reader/writer 83-3, and the display apparatus 84-3 are provided to a vehicle 80-3. The vehicles 80-1 to 80-3 are included in a composition of a train. The vehicle 80-1 has a door 81-1 and a doorway 82-1. The vehicle 80-2 has a door 81-2 and a doorway 82-2. The vehicle 80-3 has a door 81-3 and a doorway 82-3.

Each of passengers U1 to U3 boards any of the vehicles 80-1 to 80-3 from any of the doorways 82-1 to 82-3. The passenger U1 carries an IC tag 90-1. The passenger U2 carries an IC tag 90-2. The passenger U3 carries an IC tag 90-3.

Hereinafter, in a case where it is not particularly necessary to distinguish between the vehicle-mounted apparatuses 20-1 to 20-3, between the reader/writers 83-1 to 83-3, and between the display apparatuses 84-1 to 84-3, each of the vehicle-mounted apparatuses 20-1 to 20-3 is simply referred to as “vehicle-mounted apparatus 20”, each of the reader/writers 83-1 to 83-3 is simply referred to as “reader/writer 83”, and each of the display apparatuses 84-1 to 84-3 is simply referred to as “display apparatus 84”. Further, in a case where it is not particularly necessary to distinguish between the vehicles 80-1 to 80-3, between the doors 81-1 to 81-3, and between the doorways 82-1 to 82-3, each of the vehicles 80-1 to 80-3 is referred to as “vehicle 80”, each of the doors 81-1 to 81-3 is referred to as “door 81”, and each of the doorways 82-1 to 82-3 is referred to as “doorway 82”. Further, in a case where it is not particularly necessary to distinguish between the passengers U1 to U3 and between the IC tags 90-1 to 90-3, each of the passengers U1 to U3 is referred to as “passenger U”, and each of the IC tags 90-1 to 90-3 is referred to as “IC tag 90”.

Note that FIG. 5 illustrates three vehicles 80 and three passengers U, but this does not limit the number of vehicles and the number of passengers in the present example embodiment. Moreover, this does not impose a limitation that the number of vehicles and the number of passengers are the same. Furthermore, a single vehicle 80 is not limited to including a single door 81 and a single doorway 82, and may include a plurality of doors 81 and a plurality of doorways 82. Further, FIG. 5 illustrates three vehicle-mounted apparatuses 20, three reader/writers 83, and three display apparatuses 84, but this does not limit the numbers of these apparatuses in the present example embodiment. It is desirable that at least one vehicle-mounted apparatus 20 and at least one display apparatus 84 be provided to a single vehicle 80. A plurality of vehicle-mounted apparatuses 20 and a plurality of display apparatuses 84 may be provided to a single vehicle 80. Further, it is desirable that at least one reader/writer 83 be provided in a vicinity of a single doorway 82. A plurality of reader/writers 83 may be further provided in a vicinity of a single doorway 82.

(Configuration of Vehicle 80)

In the vehicle 80, the door 81 is typically closed while the train is running, and is typically open at a stop. The doorway 82 is an opening in the vehicle 80 which opening enables boarding and alighting when the door 81 is open.

(Passenger U)

The passenger U is a passenger who uses the vehicle 80. The passenger U has an attribute. The passenger U carries the IC tag 90. The passenger U may use any of a plurality of vehicles 80. A configuration of the IC tag 90 will be described later.

(Configuration of Reader/Writer 83)

The reader/writer 83 is installed in a vicinity of the doorway 82. The reader/writer 83 is an apparatus which carries out near field communication with the IC tag 90 possessed by the passenger. The reader/writer 83 drives, by a transmission wave transmitted from an antenna section (not illustrated), the IC tag 90 which is in close proximity therewith, and reads information stored in a storage section 93 of the IC tag 90 or writes information in the storage section 93. The reader/writer 83 is an example of a configuration realizing a “detection apparatus” recited in the claims.

(Configuration of Display Apparatus 84)

The display apparatus 84 is installed in the vehicle 80. The display apparatus 84 is preferably installed at a position at which the display apparatus 84 can be viewed from the passenger who is on board the vehicle 80. The display apparatus 84 displays advertisement information which corresponds to an attribute of the vehicle. For example, the display apparatus 84 is constituted by a liquid crystal display, but is not limited to this example.

(Configuration of Vehicle-Mounted Apparatus 20)

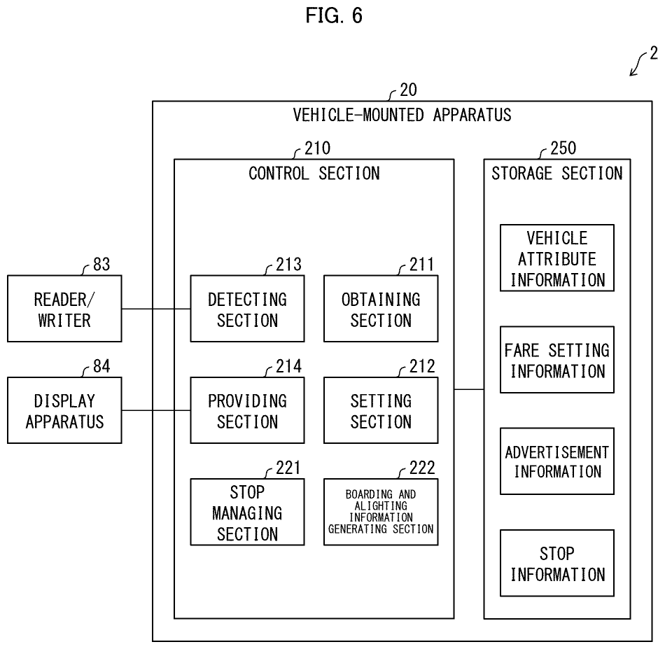

The vehicle-mounted apparatus 20 is an example of a configuration realizing a “management apparatus” recited in the claims. A configuration of the vehicle-mounted apparatus 20 is described with reference to FIG. 6. FIG. 6 is a block diagram illustrating the configuration of the vehicle-mounted apparatus 20. As illustrated in FIG. 6, the vehicle-mounted apparatus 20 includes a control section 210 and a storage section 250. The control section 210 includes an obtaining section 211, a setting section 212, a detecting section 213, a providing section 214, a stop managing section 221, and a boarding and alighting information generating section 222. The storage section 250 stores therein vehicle attribute information, fare setting information, advertisement information, and stop information.

The obtaining section 211 obtains passenger attribute information included in the information read by the reader/writer 83 from the IC tag 90. The obtaining section 211 also obtains the vehicle attribute information stored in the storage section 250 by reading the vehicle attribute information from the storage section 250.

The setting section 212 sets a fare in accordance with boarding information relating to a boarding station of the passenger U, alighting information relating to an alighting station of the passenger U, and a combination of the vehicle attribute information and the passenger attribute information.

The detecting section 213 detects the passenger by reading, with use of the reader/writer 83, the information stored in the IC tag 90.

The providing section 214 provides, in the vehicle 80, a service which corresponds to the attribute of the vehicle 80. Specifically, the providing section 214 displays, on the display apparatus 84, the advertisement information which corresponds to the attribute of the vehicle 80. Display of the advertisement information is an example of a “service which corresponds to the attribute of the at least any vehicle” recited in the claims. The providing section 214 is an example of a configuration realizing a “providing means” recited in the claims.

The stop managing section 221 detects a current stop at which the vehicle 80 is stopping, and updates the stop information stored in the storage section 250. For example, the stop managing section 221 may detect the current stop by referring to (i) a current position detected with use of a positioning sensor and (ii) predetermined operation information. The operation information includes, for example, (i) a stop at which the vehicle 80 is to stop and (ii) positional information relating to the stop.

The boarding and alighting information generating section 222 generates the boarding information relating to the boarding station of the passenger U and the alighting information relating to the alighting station of the passenger U. Details of the boarding information and the alighting information will be described later.

(Vehicle Attribute Information)

The vehicle attribute information is information indicative of the attribute of the vehicle 80. The vehicle attribute information is determined for each vehicle 80. In the present embodiment, the vehicle attribute information indicates a classification of the service provided in the vehicle 80. The service provided in the vehicle 80 is classified by, for example, a passenger bracket assumed as a target of provision of the service. In other words, in the present embodiment, the vehicle attribute information indicates the passenger bracket that is a target of provision. As a detailed example, the vehicle attribute information indicates one of “for family”, “for elderly people”, and “for commute”. Hereinafter, the vehicle 80 with respect to which the vehicle attribute information indicates “X” may be referred to as simply “vehicle 80 for X”.

(Fare Setting Information)

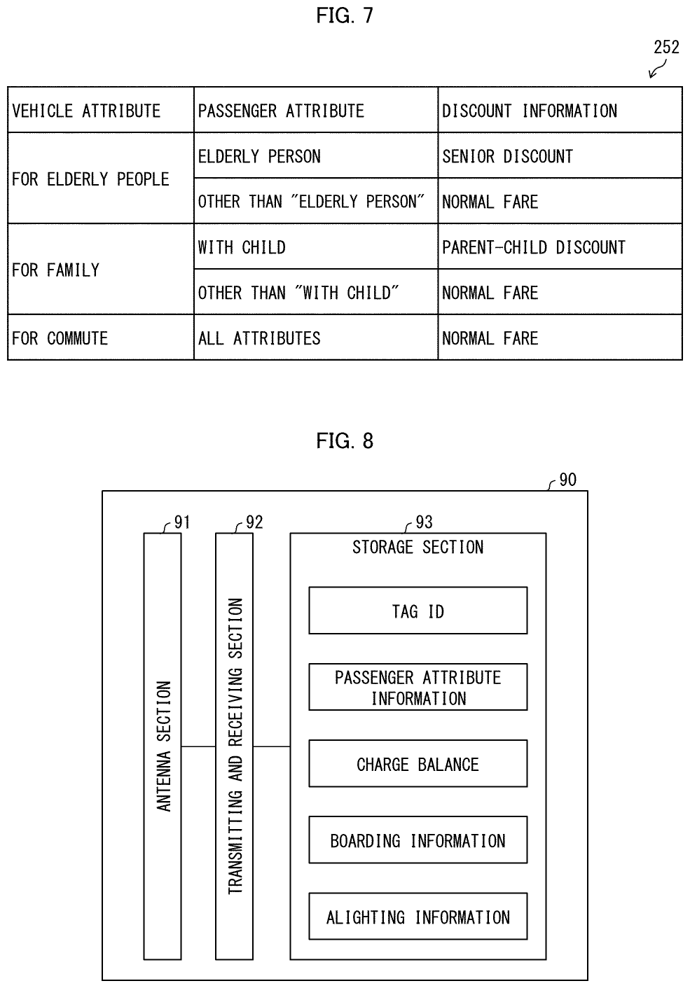

The fare setting information indicates a rule for setting the fare in accordance with the combination of the vehicle attribute information and the passenger attribute information. The fare setting information is information common to the plurality of vehicles 80. The fare setting information is described with reference to FIG. 7. FIG. 7 is a drawing illustrating an example of the fare setting information. In the example in FIG. 7, the fare setting information is constituted by information in which the vehicle attribute information, the passenger attribute information, and discount information are associated with each other. With reference to FIG. 7, for example, the vehicle attribute information “for elderly people”, the passenger attribute information “elderly person”, and the discount information “senior discount” are associated with each other. This indicates that, in a case where the passenger U who is an “elderly person” boards the vehicle 80 “for elderly people”, the senior discount is applied. Further, the vehicle attribute information “for elderly people”, the passenger attribute information “other than an “elderly person””, and the discount information “normal fare” are associated with each other. This indicates that, in a case where the passenger U other than an “elderly person” boards the vehicle 80 “for elderly people”, the normal fare is applied.

(Advertisement Information)

The advertisement information indicates an advertisement of which a content corresponds to the attribute of the vehicle 80. For example, in a case where the attribute of the vehicle 80 is “for elderly people”, the advertisement information includes an advertisement for elderly people.

(Stop Information)

The stop information includes information indicative of the current stop. The stop information is updated to the latest information by the stop managing section 221.

(IC tag 90)

The IC tag 90 stores therein information for the passenger U to use the vehicle 80. The IC tag 90 may be, for example, a transportation IC card or may be embedded in a mobile terminal. The IC tag 90 is an example of a configuration realizing a “storage medium carried by the passenger” recited in the claims. In the present embodiment, the IC tag 90 is a passive type radio-frequency tag which does not include a power supply source. A configuration of the IC tag 90 is described with reference to FIG. 8. FIG. 8 is a block diagram illustrating the configuration of the IC tag 90. As illustrated in FIG. 8, the IC tag 90 has an antenna section 91, a transmitting and receiving section 92, and the storage section 93.

The antenna section 91 receives the transmission wave from the reader/writer 83, and drives the transmitting and receiving section 92 and the storage section 93.

The transmitting and receiving section 92 carries out A/D conversion, demodulation, decoding, and the like of a signal received via the antenna section 91. The transmitting and receiving section 92 thus writes, in the storage section 93, the information received from the reader/writer 83. The transmitting and receiving section 92 also carries out encoding, modulation, A/D conversion, and the like with respect to the information stored in the storage section 93. The transmitting and receiving section 92 thus transmits the information to the reader/writer 83 via the antenna section 91.

The storage section 93 stores therein a tag ID, the passenger attribute information, a charge balance, the boarding information, and the alighting information.

(Tag ID)

The tag ID is identification information relating to the IC tag 90.

(Passenger Attribute Information)

The passenger attribute information is information indicative of the attribute of the passenger. In the present embodiment, the passenger attribute information indicates the passenger bracket assumed for the service provided by the providing section 214. For example, the passenger attribute information indicates “commuter”, “with a child” or “elderly person”, but is not limited to such examples. It is desirable that the passenger attribute information be, for example, information written on presentation of a certifying document when the IC tag 90 is issued to the passenger U. The certifying document is a document which certifies that the passenger U has the attribute indicated by the passenger attribute information. For example, the certifying document for the attribute “elderly person” may be a silver pass (i.e., senior card) issued by a local government. Alternatively, for example, the certifying document for the attribute “with a child” may be a maternal and child health handbook. However, the certifying document is not limited to the above-described examples. Hereinafter, the passenger U with respect to which the passenger attribute information indicates “X” may be referred to as simply “passenger U who is X”.

(Charge Balance)

The charge balance indicates a balance of electronic money charged in the IC tag 90 by the passenger paying a charge amount in advance. By paying the charge amount, addition to the charge balance is carried out. By deducting the fare, subtraction from the charge balance is carried out.

(Boarding Information)

The boarding information is information which indicates that the passenger U has boarded the vehicle 80. The boarding information includes information indicative of a boarding station and information indicative of a boarding time.

(Alighting Information)

The alighting information is information which indicates that the passenger U has alighted from the vehicle 80. The alighting information includes information indicative of an alighting station and information indicative of an alighting time.

<Flow of Management Method S2>

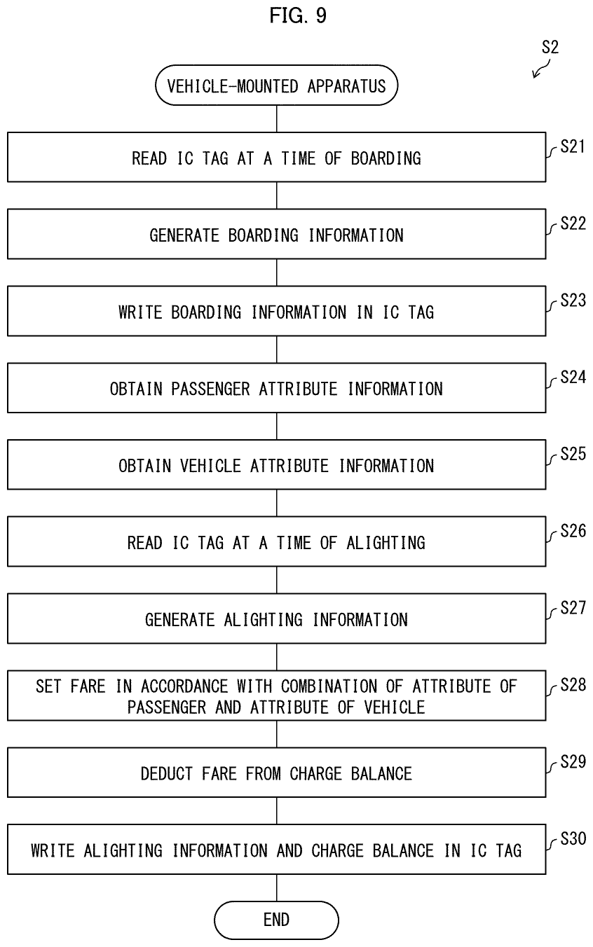

A flow of a management method S2 carried out by the management system 2 configured as described above is described with reference to FIG. 9. FIG. 9 is a flowchart illustrating the flow of the management method S2. As illustrated in FIG. 9, the management method S2 includes steps S21 to S30.

(Step S21)

In the step S21, the detecting section 213 detects the passenger U who boards the vehicle 80, by reading information from the IC tag 90 with use of the reader/writer 83.

(Step S22)

In the step S22, the boarding and alighting information generating section 222 generates boarding information. Specifically, the boarding and alighting information generating section 422 reads the latest stop information from the storage section 250. The boarding and alighting information generating section 222 generates the boarding information including information indicative of (i) a boarding station which is a stop indicated by the stop information and (ii) a boarding time which is a current time.

(Step S23)

In the step S23, the boarding and alighting information generating section 222 writes the boarding information in the IC tag 90 with use of the reader/writer 83.

(Step S24)

In the step S24, the obtaining section 211 obtains passenger attribute information included in the information read by the reader/writer 83.

(Step S25)

In the step S25, the obtaining section 211 obtains vehicle attribute information by reading the vehicle attribute information from the storage section 250.

(Step S26)

In the step S26, the detecting section 213 detects the passenger U who alights from the vehicle 80, by reading the information from the IC tag 90 with use of the reader/writer 83.

(Step S27)

In the step S27, the boarding and alighting information generating section 222 generates alighting information. Specifically, the boarding and alighting information generating section 222 reads the latest stop information from the storage section 250. The boarding and alighting information generating section 222 generates the alighting information including information indicative of (i) an alighting station which is a stop indicated by the stop information and (ii) an alighting time which is a current time.

(Step S28)

In the step S28, the setting section 212 sets a fare by applying, to a normal fare which is determined with respect to a section in which the passenger U boards the vehicle 80, a discount which corresponds to a combination of the vehicle attribute information and the passenger attribute information. Specifically, the setting section 212 calculates the normal fare in accordance with a given fare rule on the basis of the boarding station indicated by the boarding information and the alighting station indicated by the alighting information. The setting section 212 also refers to fare setting information, and obtains discount information associated with the combination of the vehicle attribute information and the passenger attribute information. The setting section 212 then calculates the fare which is obtained by applying the discount information to the normal fare.

(Step S29)

In the step S29, the setting section 212 deducts the fare from a charge balance included in the information read by the reader/writer 83, and calculates the charge balance after deduction.

(Step S30)

In the step S30, the boarding and alighting information generating section 222 writes, in the IC tag 90, the alighting information and the charge balance after the deduction, with use of the reader/writer 83.

### First Detailed Example

Detailed examples of the present example embodiment are described.

Here, the attribute of the vehicle 80-1 is “for elderly people”. Therefore, the vehicle-mounted apparatus 20-1 stores therein the vehicle attribute information indicative of “for elderly people”. A facility (handrail, etc.) for elderly people is installed in the vehicle 80-1. The facility for elderly people is an example of the “service which corresponds to the attribute of the at least any vehicle” recited in the claims. The vehicle-mounted apparatus 20-1 stores therein, as the advertisement information, information for elderly people, such as information relating to health and information relating to inheritance, and displays the information on the display apparatus 84-1.

The attribute of the vehicle 80-2 is “for family”. Therefore, the vehicle-mounted apparatus 20-2 stores therein the vehicle attribute information indicative of “for family”. A facility for family (e.g., stroller placement space) is installed in the vehicle 80-2. The facility for family is an example of the “service which corresponds to the attribute of the at least any vehicle” recited in the claims. The vehicle-mounted apparatus 20-2 stores therein, as the advertisement information, information relating to amusement, and displays the information on the display apparatus 84-2.

The attribute of the vehicle 80-3 is “for commute”. Therefore, the vehicle-mounted apparatus 20-3 stores therein the vehicle attribute information indicative of “for commute”. The vehicle-mounted apparatus 20-3 stores therein, as the advertisement information, information relating to news, and displays the information on the display apparatus 84-3.

(Boarding of Elderly Person)

The passenger U1 is assumed to be an elderly person. The IC tag 90-1 carried by the passenger U1 stores therein the passenger attribute information indicative of “elderly person”. This information has been written by the passenger U1 presenting a silver pass at a time of issuance of the IC tag 90-1.

In a case where the passenger U1 boards the vehicle 80-1, the vehicle-mounted apparatus 20-1 reads the information stored in the IC tag 90-1. The management system 2 carries out the management method S2. The vehicle-mounted apparatus 20-1 thus obtains the passenger attribute information “elderly person” stored in the IC tag 90-1. The vehicle-mounted apparatus 20-1 also obtains the vehicle attribute information “for elderly people” stored in the storage section 250. The vehicle-mounted apparatus 20-1 writes the boarding information in the IC tag 90-1.

Thereafter, when the passenger U1 alights from the vehicle 80-1, the vehicle-mounted apparatus 20-1 reads the information stored in the IC tag 90-1. The vehicle-mounted apparatus 20-1 also generates the alighting information. The vehicle-mounted apparatus 20-1 then calculates the fare by applying the discount information “senior discount” to the normal fare. The discount information “senior discount” corresponds to a combination of the vehicle attribute information “for elderly people” and the passenger attribute information “elderly person”. The normal fare has been calculated in accordance with the boarding information and the alighting information. The vehicle-mounted apparatus 20-1 then deducts the fare from the charge balance. The vehicle-mounted apparatus 20-1 writes, in the IC tag 90-1, the charge balance after deduction and the alighting information.

Note that in a case where the passenger U1 boards the vehicle 80-2, the “normal fare” is applied which corresponds to a combination of the vehicle attribute information “for family” and the passenger attribute information “elderly person”. Similarly, in a case where the passenger U1 boards the vehicle 80-3, the “normal fare” is applied which corresponds to a combination of the vehicle attribute information “for commute” and the passenger attribute information “elderly person”.

Thus, the passenger U1 who is an “elderly person” can receive the service for elderly people at the senior discount, by boarding the vehicle 80-1 “for elderly people” which is included in the plurality of vehicles 80. Therefore, a level of satisfaction is improved.

(Boarding with Child)

In a case where the passenger U2 boards the vehicle 80-2, the vehicle-mounted apparatus 20-2 reads the information stored in the IC tag 90-2. The management system 2 carries out the management method S2. Thus, the vehicle-mounted apparatus 20-2 obtains the passenger attribute information “with a child” stored in the IC tag 90-2. The vehicle-mounted apparatus 20-2 also obtains the vehicle attribute information “for family” stored in the storage section 250. The vehicle-mounted apparatus 20-2 writes the boarding information in the IC tag 90-2.

In a case where the passenger U2 alights from the vehicle 80-2, the vehicle-mounted apparatus 20-2 reads the information stored in the IC tag 90-2. The vehicle-mounted apparatus 20-2 also generates the alighting information. The vehicle-mounted apparatus 20-2 then calculates the fare by applying the discount information “parent-child discount” to the normal fare. The discount information “parent-child discount” corresponds to a combination of the vehicle attribute information “for family” and the passenger attribute information “with a child”. The normal fare has been calculated in accordance with the boarding information and the alighting information. The vehicle-mounted apparatus 20-2 then deducts the fare from the charge balance. The vehicle-mounted apparatus 20-2 writes, in the IC tag 90-2, the charge balance after deduction and the alighting information.

Note that in a case where the passenger U2 boards the vehicle 80-1, the “normal fare” is applied which corresponds to a combination of the vehicle attribute information “for elderly people” and the passenger attribute information “with a child”. Similarly, in a case where the passenger U2 boards the vehicle 80-3, the “normal fare” is applied which corresponds to a combination of the vehicle attribute information “for commute” and the passenger attribute information “with a child”.

Thus, the passenger U2 who is “with a child” can receive the service for family at the parent-child discount, by boarding the vehicle 80-2 “for family” which is included in the plurality of vehicles 80. Therefore, a level of satisfaction is improved.

(Boarding of Commuter)

It is assumed that the passenger U3 is a commuter. The IC tag 90-3 carried by the passenger U3 stores therein the passenger attribute information indicative of “general”.

In a case where the passenger U3 boards the vehicle 80-3, the vehicle-mounted apparatus 20-3 reads the information stored in the IC tag 90-3. The management system 2 carries out the management method S2. Thus, the vehicle-mounted apparatus 20-3 obtains the passenger attribute information “general” stored in the IC tag 90-3. The vehicle-mounted apparatus 20-3 also obtains the vehicle attribute information “for commute” stored in the storage section 250. The vehicle-mounted apparatus 20-3 writes the boarding information in the IC tag 90-3.

Then, in a case where the passenger U3 alights from the vehicle 80-3, the vehicle-mounted apparatus 20-3 reads the information stored in the IC tag 90-3. The vehicle-mounted apparatus 20-3 also generates the alighting information. Note, here, that the discount information which corresponds to a combination of the vehicle attribute information “for commute” and the passenger attribute information “general” is the “normal fare”. Therefore, the vehicle-mounted apparatus 20-3 deducts, from the charge balance, the normal fare calculated in accordance with the boarding information and the alighting information. The vehicle-mounted apparatus 20-3 writes, in the IC tag 90-3, the charge balance after deduction and the alighting information.

Note that in a case where the passenger U3 boards the vehicle 80-1, the “normal fare” is applied which corresponds to a combination of the vehicle attribute information “for elderly people” and the passenger attribute information “general”. Similarly, in a case where the passenger U3 boards the vehicle 80-2, the “normal fare” is applied which corresponds to a combination of the vehicle attribute information “for family” and the passenger attribute information “general”.

Thus, since the passenger U3 who is “general” is provided with the service for commute by boarding the vehicle 80-3 “for commute” which is included in the plurality of vehicles 80, a level of satisfaction is improved.

In the present detailed example, the passengers U1 to U3 are expected to board, out of the plurality of vehicles 80, respective different vehicles 80 each of which has an attribute that allows a discount to be applied in combination with the attribute of a corresponding one of the passengers U1 to U3. Therefore, even in a case where convenience of the vehicle 80-3 is higher than that of the other vehicles 80, a degree of congestion on the vehicle 80-3 is reduced as compared with those on the other vehicles 80. Therefore, a level of satisfaction in a case where the passenger U3 who is “general” boards the vehicle 80-3 “for commute” is also improved.

### Effects of the Present Example Embodiment

In the present example embodiment, the discount information is applied which corresponds to the combination of (i) the passenger attribute information that has been read from the IC tag 90 carried by the passenger U and (ii) the vehicle attribute information that relates to the vehicle 80 in which the passenger U has been detected. This makes it possible for the passenger U to board, at an appropriate discount fare, the vehicle 80 which is suitable for his/her attribute, simply by holding the IC tag 90 over the reader/writer 83 when boarding and alighting from the vehicle 80. As a result, a level of satisfaction is improved.

Moreover, in the present example embodiment, the service which corresponds to the vehicle attribute information is provided in each vehicle 80, and the discount information is set in accordance with the target of provision of the service. This makes it possible to compose a train in which the plurality of vehicles 80 having different fare systems are mixed.

Furthermore, in the present example embodiment, it is expected that the passenger U boards the vehicle 80 which provides the service suitable for his/her attribute. This reduces congestion without bias of passengers U on a particular vehicle 80.

In addition, in the present example embodiment, the reader/writer 83 provided to the doorway 82 has a ticket checking function. Therefore, it is not necessary to install a ticket gate for entry into a station. As a result, it is expected that people other than the passenger U of the vehicle 80 use a facility in the station. This leads to higher profits.

### Fourth Example Embodiment

A third example embodiment of the present invention is described in detail with reference to drawings. The present example embodiment is an embodiment which realizes setting of a fare which corresponds to an attribute of a passenger and an attribute of a vehicle, with use of face recognition with respect to a passenger who has made a reservation.

<Configuration of Management System 3>

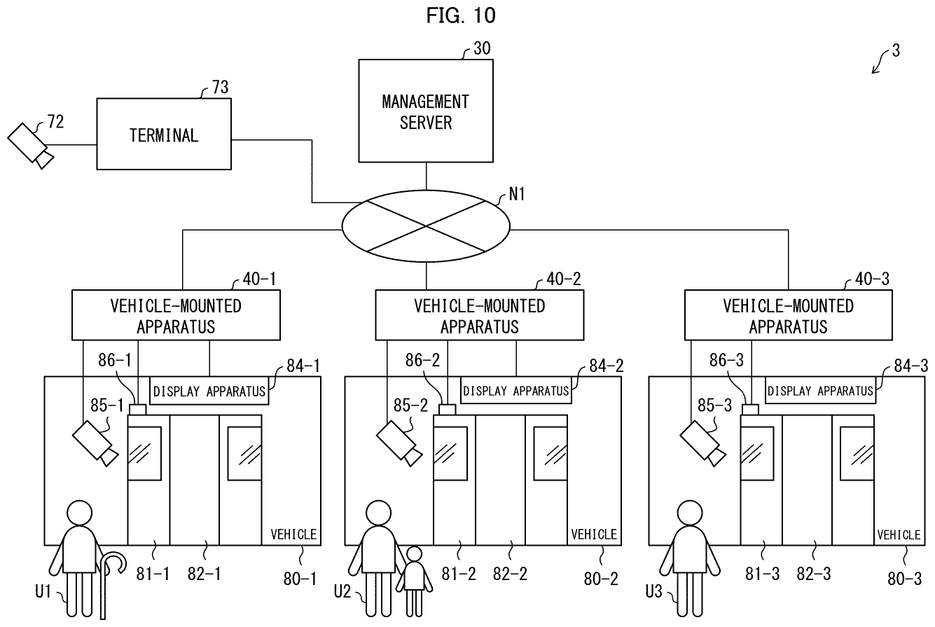

A configuration of a management system 3 in accordance with the present example embodiment is described with reference to FIG. 10. FIG. 10 is a block diagram illustrating the configuration of the management system 3. As illustrated in FIG. 10, the management system 3 includes a management server 30, a terminal 71, vehicle-mounted apparatuses 40-1 to 40-3, cameras 85-1 to 85-3, opening and closing apparatuses 86-1 to 86-3, and display apparatuses 84-1 to 84-3. The vehicle-mounted apparatus 40-1, the camera 85-1, the opening and closing apparatus 86-1, and the display apparatus 84-1 are provided to a vehicle 80-1. The vehicle-mounted apparatus 40-2, the camera 85-2, the opening and closing apparatus 86-2, and the display apparatus 84-2 are provided to a vehicle 80-2. The vehicle-mounted apparatus 20-3, the camera 85-3, the opening and closing apparatus 86-3, and the display apparatus 84-3 are provided to a vehicle 80-3. The display apparatuses 84, the vehicles 80, doors 81, doorways 82, and passengers U are as described in the third example embodiment. The management server 30, the vehicle-mounted apparatuses 40-1 to 40-3, and the terminal 71 are communicably connected to each other via a network N1. A detailed example of the network N1 is, for example, a wireless local area network (LAN), a wired LAN, a WAN, a public network, a mobile data communication network, or a combination of these networks. Note, however, that a configuration of the network N1 is not limited to these examples. Hereinafter, in a case where it is not particularly necessary to distinguish between the vehicle-mounted apparatuses 40-1 to 40-3, between the cameras 85-1 to 85-3, and between the opening and closing apparatuses 86-1 to 86-3, each of the vehicle-mounted apparatuses 40-1 to 40-3 is simply referred to as “vehicle-mounted apparatus 40”, each of the cameras 85-1 to 85-3 is simply referred to as “camera 85”, and each of the opening and closing apparatuses 86-1 to 86-3 is simply referred to as “opening and closing apparatus 86”. Note that FIG. 10 illustrates a single management server 30 and a single terminal 71, but this does not limit the numbers of these apparatuses included in the present example embodiment. It is desirable that at least one camera 85 be provided in a vicinity of a single doorway 82. A plurality of cameras 85 may be further provided in a vicinity of a single doorway 82.

(Configuration of Camera 85)

The camera 85 is installed in a vicinity of a doorway 82-1. The camera 85-2 is installed in a vicinity of a doorway 82-2. The camera 85-3 is installed in a vicinity of a doorway 82-3. The camera 85 is an apparatus which converts light condensed by a lens into an image signal by an image sensor and which generates a captured image on the basis of the image signal. The camera 85 is installed such that the lens faces in a direction in which the camera 85 can capture both an image of the passenger who boards from the doorway 82 and an image of the passenger who alights from the doorway 82. The camera 85 is an example of the “detection apparatus” recited in the claims.

(Configuration of Opening and Closing Apparatus 86)

The opening and closing apparatus 86 is an apparatus which controls opening and closing of the door 81. The opening and closing apparatus 86 controls opening and closing of the door 81 in accordance with control information received from an opening and closing control section 415 (described later). The opening and closing apparatus 86 also detects whether the door 81 is open or closed, and transmits this detected information to the opening and closing control section 415.

(Configuration of Terminal 71)

The terminal 71 is a computer operated by the passenger U. The terminal 71 functions as a terminal on which a reservation service provided by the management server 30 is used. Specifically, an input apparatus (not illustrated), a display apparatus (not illustrated), and a camera 72 are connected to the terminal 71. Alternatively, a part or all of the input apparatus, the display apparatus, and the camera 72 may be embedded in the terminal 71. The terminal 71 displays, on the display apparatus, information received from the management server 30. The terminal 71 transmits, to the management server 30, information obtained via the input apparatus or the camera 72.

(Configuration of Management Server 30)

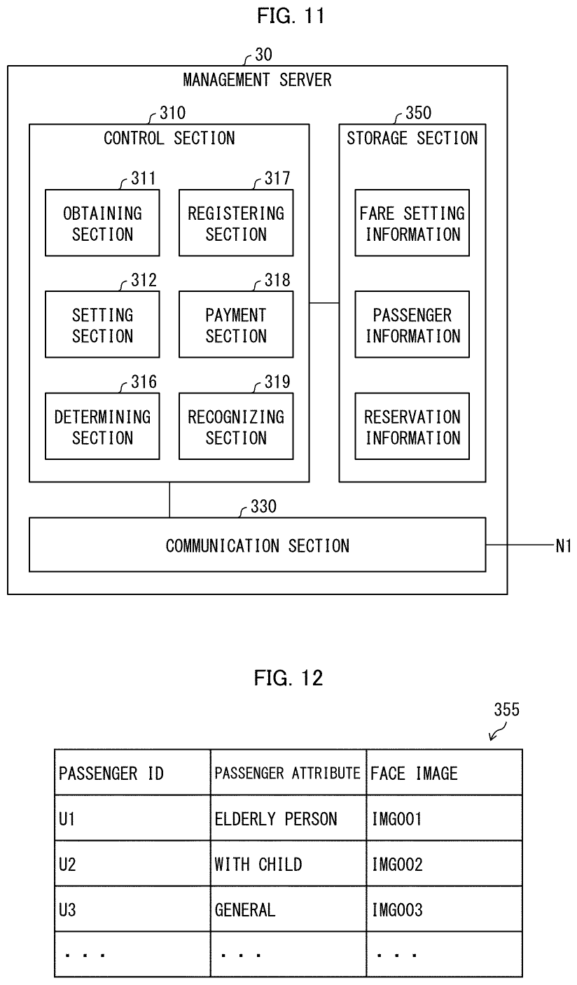

The management server 30 is an example of a configuration realizing at least a part of the “management apparatus” recited in the claims. A configuration of the management server 30 is described with reference to FIG. 11. FIG. 11 is a block diagram illustrating the configuration of the management server 30. As illustrated in FIG. 11, the management server 30 includes a control section 310, a storage section 350, and a communication section 330. The control section 310 includes an obtaining section 311, a setting section 312, a determining section 316, a registering section 317, a payment section 318, and a recognizing section 319. The storage section 350 includes fare setting information, passenger information, and reservation information. The communication section 330 transmits and receives information to and from the vehicle-mounted apparatus 40 and the terminal 71 on the basis of control by the control section 310. Hereinafter, transmitting and receiving various kinds of information by the communication section 330 are referred to as simply transmitting and receiving various kinds of information.

The obtaining section 311 obtains (i) a face image of the passenger U who has been detected in the vicinity of the doorway 82 of the vehicle 80 and (ii) vehicle attribute information, by receiving the face image and the vehicle attribute information from the vehicle-mounted apparatus 40. The obtaining section 311 also obtains passenger attribute information associated with the face image of the passenger U, by referring to the passenger information.

The setting section 312 sets a fare in accordance with a combination of vehicle attribute information relating to the vehicle 80 which is to be used by the passenger U and the passenger attribute information included in the passenger information.

The determining section 316 determines whether or not the vehicle attribute information relating to the vehicle 80 having the doorway 82 in which the camera 85 has detected the passenger U matches the vehicle attribute information included in the reservation information relating to the passenger U. The determining section 316 also determines whether or not to permit boarding of the passenger U, on the basis of this determination result. Specifically, in the case where the determining section 316 permits boarding, the determining section 316 controls the door 81 to be open. In the case where the determining section 316 does not permit boarding, the determining section 316 controls the door 81 to be closed.

The registering section 317 receives, from the terminal 71, information for use of the reservation service, and registers the passenger information and the reservation information. Note that registering is storing in the storage section 350. Details of the passenger information and the reservation information will be described later.

The payment section 318 performs payment of the fare. Specifically, the payment section 318 requests payment of the passenger fare with respect to a payment server (not illustrated) indicated by payment information specified by the passenger U. The payment section 318 thus performs the payment.

The recognizing section 319 carries out recognition by face images. A known technique can be applied to a face recognition technique. The recognizing section 319 determines whether or not a face image which has been received from the terminal 71 or the vehicle-mounted apparatus 40 and a face image which is included in the passenger information indicate an identical person.

(Fare Setting Information)

A configuration of the fare setting information in the present example embodiment is as described with reference to FIG. 7 in the third example embodiment.

(Passenger Information)

The passenger information is information indicative of the passenger U. The passenger information is described with reference to FIG. 12. FIG. 12 is a drawing illustrating an example of the passenger information. The passenger information includes information indicative of a passenger ID, information indicative of a passenger attribute, and information indicative of a face image. In this example, passenger IDs of the passengers U1 to U3 are respectively U1 to U3. For example, the passenger attribute of the passenger U1 is “elderly person”. An image IMG001 is registered as the face image of the passenger U1. Note that the storage section 350 which stores therein the passenger information including the face image and the passenger attribute information is an example of the configuration realizing the “storage means” recited in the claims.

(Reservation Information)

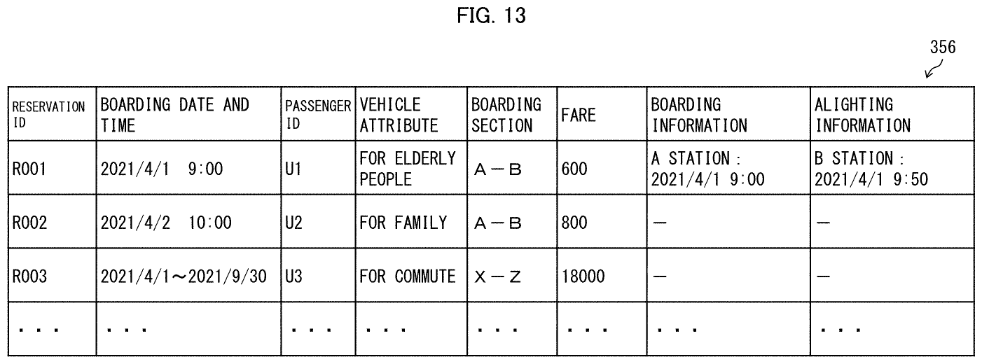

The reservation information is information indicative of a reservation of use of the vehicle U by the passenger U. The reservation information is described with reference to FIG. 13. FIG. 13 is a drawing illustrating an example of the reservation information. The reservation information includes information indicative of a reservation ID, information indicative of boarding date and time, information indicative of a passenger ID, information indicative of a vehicle attribute, information indicative of a boarding section, and information indicative of a fare. These are information determined at a time of reservation. The reservation information further includes boarding information and alighting information. These are information determined by the passenger U boarding and alighting from the vehicle 80 in accordance with the reservation indicated by the reservation information.

For example, the reservation information of the reservation ID 001 indicates that the passenger U1 is to board the vehicle 80 for elderly people in the boarding section A-B at 9:00 on 2021/4/1. The reservation information of the reservation ID 003 includes information indicative of a period as the boarding date and time. In this case, the reservation information of the reservation ID 003 indicates information relating to a commuter ticket which is valid for the period registered as the boarding date and time. That is, the reservation information of the reservation ID 003 indicates the information relating to the commuter ticket with which the passenger U3 boards the vehicle 80 for commute in the boarding section X-Z, and an effective period of the commuter ticket is 2021/4/1 to 2021/9/30.

(Configuration of Vehicle-Mounted Apparatus 40)

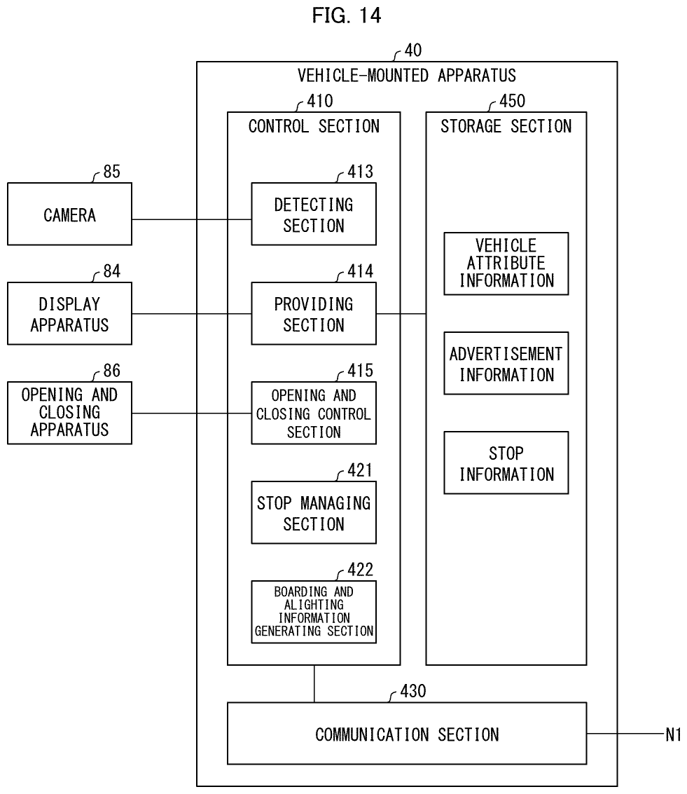

The vehicle-mounted apparatus 40 is an example of a configuration realizing at least a part of the “management apparatus” recited in the claims. A configuration of the vehicle-mounted apparatus 40 is described with reference to FIG. 14. FIG. 14 is a block diagram illustrating the configuration of the vehicle-mounted apparatus 40. As illustrated in FIG. 14, the vehicle-mounted apparatus 40 includes a control section 410, a storage section 450, and a communication section 430. The control section 410 includes a detecting section 413, a providing section 414, the opening and closing control section 415, a stop managing section 421, and a boarding and alighting information generating section 422. The storage section 450 stores therein the vehicle attribute information, advertisement information, and stop information. The communication section 430 transmits and receives information to and from the management server 30 on the basis of control by the control section 410. Hereinafter, transmitting and receiving various kinds of information by the communication section 430 are referred to as simply transmitting and receiving various kinds of information. The stop managing section 421 and the boarding and alighting information generating section 422 are configured similarly to respective functional blocks having the same names in the third example embodiment. The vehicle attribute information, the advertisement information, and the stop information are as described in the third example embodiment.

The detecting section 413 detects the passenger U by extracting the face image from an image captured by the camera 85. Here, the face image is an example of “biometric information” recited in the claims.

The opening and closing control section 415 controls opening and closing of the door 81 by transmitting control information to the opening and closing apparatus 86. The opening and closing control section 415 also receives, from the opening and closing apparatus 86, information indicative of whether the door 81 is open or closed.

<Flow of Reservation Method S3>

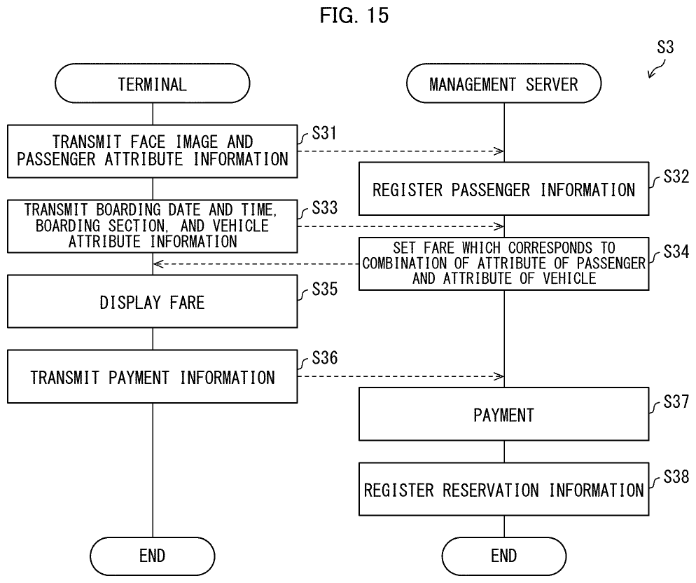

A flow of a reservation method S3 carried out in the reservation service by the management system 3 configured as described above is described with reference to FIG. 15. FIG. 15 is a flowchart illustrating the flow of the reservation method S3 for reserving use of the vehicle 80. As illustrated in FIG. 15, the reservation method S3 includes steps S31 to S39.

(Step S31)

In the step S31, the terminal 71 obtains a face image of the passenger U and passenger attribute information, and transmits the face image and the passenger attribute information to the management server 30. For example, the terminal 71 may obtain the face image of the passenger U by extracting the face image from an image captured by the camera 72. Alternatively, the terminal 71 may obtain the face image stored in a memory of the terminal 71 by reading the face image. Further, for example, the terminal 71 may obtain the passenger attribute information which is inputted with use of the input apparatus of the terminal 71. The terminal 71 may further obtain certification information in addition to the passenger attribute information, and transmit the certification information to the management server 30. The certification information is information indicative of a certifying document which certifies an attribute of the passenger U. For example, the certification information may be an image including, as a subject, a silver pass or a maternal and child health handbook each of which is an example of the above-described certifying document.

(Step S32)

In the step S32, the registering section 317 of the management server 30 generates passenger information including the passenger attribute information and the face image, on the basis of the information received from the terminal 71. The registering section 317 registers the generated passenger information. Note that, in a case where the certification information is received, the registering section 317 may determine whether or not the received passenger attribute information is appropriate, with reference to the certification information. In this case, in a case where the registering section 317 determines that the passenger attribute information is appropriate, the registering section 317 registers the passenger information. In a case where the registering section 317 determines that the passenger attribute information is not appropriate, the registering section 317 ends the reservation method S3.

(Step S33)

In the step S33, the terminal 71 obtains boarding date and time, a boarding section, and vehicle attribute information each of which is desired by the passenger U, and transmits the boarding date and time, the boarding section, and the vehicle attribute information to the management server 30. For example, the terminal 71 may obtain these pieces of information which are inputted with use of the input apparatus of the terminal 71.

(Step S34)

In the step S34, the setting section 312 of the management server 30 sets a fare which corresponds to a combination of the passenger attribute information and the vehicle attribute information, on the basis of the boarding date and time, the boarding section, and the vehicle attribute information received from the terminal 71. The setting section 312 transmits the set fare to the terminal 71.

Specifically, the setting section 312 refers to the boarding section, and calculates a normal fare in accordance with a given fare rule. The setting section 312 also obtains discount information associated with the combination, with reference to fare setting information. The setting section 312 sets the fare by applying the discount information to the normal fare.

(Step S35)

In the step S35, the terminal 71 displays the received fare on the display apparatus.

(Step S36)

In the step S36, the terminal 71 obtains payment information, and transmits the payment information to the management server 30. For example, the terminal 71 may obtain payment information which is inputted with use of the input apparatus of the terminal 71. The payment information is information necessary to collect the fare from the passenger U, and is, for example, information relating to a credit card, electronic money, or the like. However, the payment information is not limited to these examples.

(Step S37)

In the step S37, the payment section 318 of the management server 30 performs payment with use of the received payment information.

(Step S38)

In the step S38, the registering section 317 generates reservation information including a reservation ID, a passenger ID, the boarding date and time, the boarding section, and the vehicle attribute information. The registering section 317 registers the generated reservation information.

<Flow of Management Method S4 at a Time of Boarding>

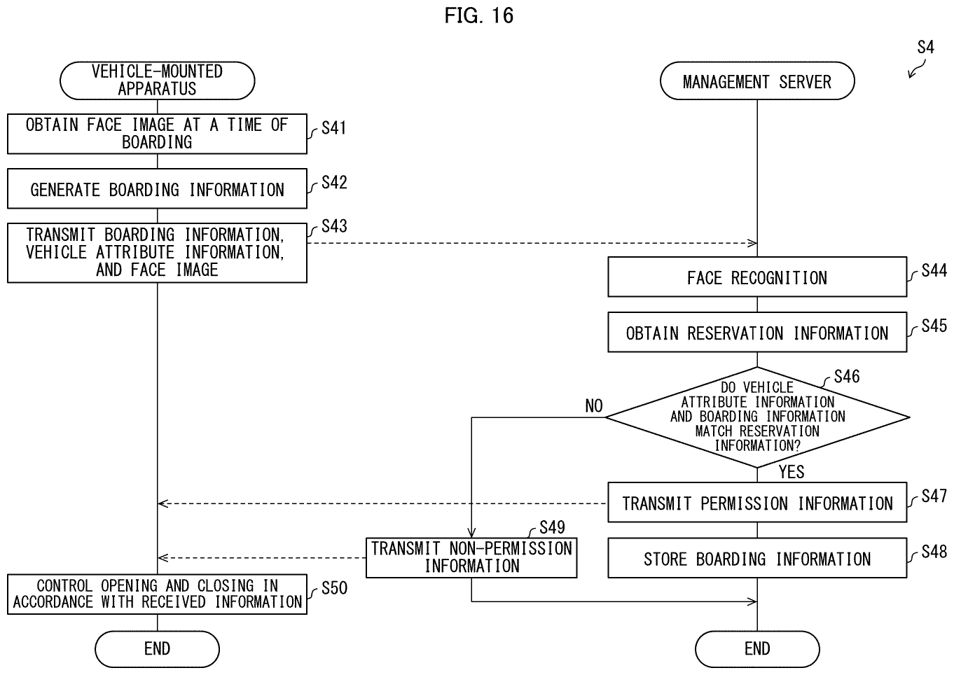

A flow of a management method S4 carried out by the management system 3 is described with reference to FIG. 16. FIG. 16 is a flowchart illustrating the flow of the management method S4 which is carried out at a time of boarding of the passenger U. As illustrated in FIG. 13, the management method S4 includes steps S41 to S50.

(Step S41)

In the step S41, the detecting section 413 of the vehicle-mounted apparatus 40 detects the passenger who boards the vehicle 80, by extracting a face image of the passenger U from an image captured by the camera 85.

(Step S42)

In the step S42, the boarding and alighting information generating section 422 generates boarding information. Specifically, the boarding and alighting information generating section 422 reads the latest stop information from the storage section 450. The boarding and alighting information generating section 422 generates the boarding information including information indicative of (i) a boarding station which is a stop indicated by the stop information and (ii) a boarding time which is a current time.

(Step S43)

In the step S43, the detecting section 413 transmits, to the management server 30, the boarding information which has been generated in the step S42, vehicle attribute information which is stored in the storage section 450, and the face image which has been obtained in the step S41.

(Step S44)

In the step S44, the recognizing section 319 carries out face recognition with use of the received face image. Specifically, in a case where the recognizing section 319 can determine that the received face image and the face image included in the passenger information stored in the storage section 350 indicates an identical person, the recognizing section 319 determines that the face recognition has succeeded. Hereinafter, the passenger U indicated by such passenger information is also referred to as “passenger U who has succeeded in the face recognition”. Further, the passenger ID included in such passenger information is also referred to as “passenger ID which has succeeded in the face recognition”. Note that, in a case where the face recognition is not successful, the management server 30 ends the management method S4.

(Step S45)

In the step S45, the determining section 316 obtains, from the storage section 350, the reservation information including the passenger ID which has succeeded in the face recognition.

(Step S46)

In the step S46, the determining section 316 determines whether or not the vehicle attribute information and the boarding information received from the vehicle-mounted apparatus 40 match the reservation information. Specifically, in a case where the vehicle attribute information received from the vehicle-mounted apparatus 40 matches the vehicle attribute information included in the reservation information, the determining section 316 determines that the vehicle attribute information matches the reservation information. In a case where the vehicle attribute information received from the vehicle-mounted apparatus 40 does not match the vehicle attribute information included in the reservation information, the determining section 316 determines that the vehicle attribute information does not match the reservation information. In a case where the boarding station indicated by the boarding information received from the vehicle-mounted apparatus 40 is included in the section indicated by the reservation information, the determining section 316 determines that the boarding information matches the reservation information. In a case where the boarding station is not included in the section, the determining section 316 determines that the boarding information does not match the reservation information. In a case where both of the vehicle attribute information and the boarding information match the reservation information, the determining section 316 makes a determination of “YES” in this step. In a case where at least one of the vehicle attribute information and the boarding information does not match the reservation information, the determining section 316 makes a determination of “NO”.

(YES in step S46: step S47)

In a case where a determination of YES is made in the step S46, the determining section 316 transmits permission information to the vehicle-mounted apparatus 40 in the step S47.

(Step S48)

In the step S48, the registering section 317 updates the reservation information stored in the storage section 350 so that the reservation information includes the boarding information received from the vehicle-mounted apparatus 40.

(NO in step S46: step S49)

In a case where a determination of NO is made in the step S46, the determining section 316 transmits non-permission information to the vehicle-mounted apparatus 40 in the step S49.

(Step S50)

In the step S50, the opening and closing control section 415 of the vehicle-mounted apparatus 40 controls opening and closing of the door 81, in accordance with the received information. Specifically, in a case where the permission information has been received, the opening and closing control section 415 controls an opening and closing control apparatus to open the door 81. Note that, in a case where the permission information has been received and the door 81 is already open, the opening and closing control section 415 leaves the door 81 open without controlling the opening and closing control apparatus. In a case where the non-permission information has been received, the opening and closing control section 415 controls the opening and closing control apparatus to close the door 81. Note that, in a case where the non-permission information has been received and the door 81 is already closed, the opening and closing control section 415 leaves the door 81 closed without controlling the opening and closing control apparatus.

<Flow of Management Method S5 at a Time of Alighting>

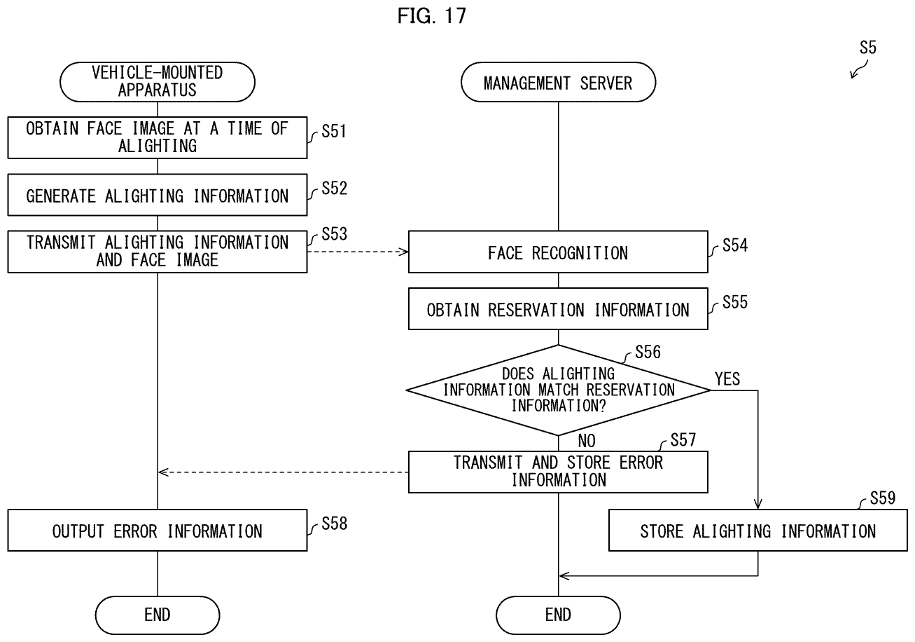

A flow of a management method S5 carried out by the management system 3 is described with reference to FIG. 17. FIG. 17 is a flowchart illustrating the flow of the management method S5 which is carried out at a time of alighting of the passenger U. As illustrated in FIG. 17, the management method S5 includes steps S51 to S59.

(Step S51)

In the step S51, the detecting section 413 of the vehicle-mounted apparatus 40 detects the passenger who boards the vehicle 80, by extracting a face image of the passenger U from an image captured by the camera 85.

(Step S52)

In the step S52, the boarding and alighting information generating section 422 generates alighting information. Specifically, the boarding and alighting information generating section 422 reads the latest stop information from the storage section 450. The boarding and alighting information generating section 422 generates the alighting information including information indicative of (i) an alighting station which is a stop indicated by the stop information and (ii) an alighting time which is a current time.

(Step S53)

In the step S53, the boarding and alighting information generating section 422 transmits, to the management server 30, the alighting information which has been generated in the step S52 and the face image which has been obtained in the step S51.

(Step S54)

In the step S54, the recognizing section 319 carries out face recognition with use of the received face image. Details of this step are as described in connection with the step S44. Note that, in a case where the face recognition is not successful, the management server 30 ends the management method SS.

(Step S55)

In the step S55, the determining section 316 obtains, from the storage section 350, the reservation information including the passenger ID which has succeeded in the face recognition.

(Step S56)

In the step S56, the determining section 316 determines whether or not the alighting information received from the vehicle-mounted apparatus 40 matches the reservation information. Specifically, in a case where the alighting station indicated by the alighting information received from the vehicle-mounted apparatus is included in the section indicated by the reservation information, the determining section 316 determines that the alighting information matches the reservation information. In a case where the alighting station is not included in the section, the determining section 316 determines that the alighting information does not match the reservation information.

(NO in Step S56: Step S57)

In a case where a determination of NO is made in the step S56, the determining section 316 transmits error information to the vehicle-mounted apparatus 40 and also stores the error information in the storage section 550 in the step S57. For example, the determining section 316 may update the reservation information stored in the storage section 350 by including the error information, in place of the alighting information, in reservation information. The fact that the alighting station does not match the reservation information is thus recorded.

(Step S58)

In the step S58, the vehicle-mounted apparatus 40 outputs the received error information. For example, the vehicle-mounted apparatus 40 may output the error information to the display apparatus or a speaker (both not illustrated) each of which is installed in the vicinity of the doorway 82. The passenger U can thus recognize that the alighting station does not match the reservation information.

(YES in Step S56: Step S59)

In a case where a determination of YES is made in the step S56, the registering section 317 updates, in the step S59, the reservation information stored in the storage section 350 so that the reservation information includes the alighting information received from the vehicle-mounted apparatus 40.

### Second Detailed Example

Detailed examples of the present example embodiment are described. Here, the vehicle attribute information relating to the vehicles 80-1 to 80-3 respectively indicate “for elderly people”, “for family” and “for commute”, similarly to the first detailed example of the third example embodiment. The passengers U1 to U3 are respectively an elderly person, a passenger with a child, and a commuter, similarly to the detailed examples of the third example embodiment.

(Reservation for Elderly Person)

The passenger U1 reserves use of the vehicle 80-1 with use of the terminal 71. Specifically, the passenger U1 inputs, into the terminal 71, a face image, the passenger attribute information “elderly person”, and an image including a silver pass as a subject. The passenger U1 also inputs, into the terminal 71, the vehicle attribute information “for elderly people”, the boarding date and time “9:00 on 2021/4/1”, and the boarding section “A-B”, as contents of a reservation. The management system 3 carries out the reservation method S3.

The management server 30 thus determines that the certification information is appropriate, and, with respect to the passenger U1, the management server 30 registers the passenger information including the passenger ID “U1”, the face image, and the passenger attribute information “elderly person”. Further, the management server 30 applies the discount information “senior discount” in accordance with a combination of the passenger attribute information “elderly person” which is included in the passenger information relating to the passenger U1 and the vehicle attribute information “for elderly people” which has been received as a content of the reservation from the terminal 71, and then performs payment.

The management server 30 also issues the reservation ID “R001”, and registers the reservation information including the passenger ID “U1”, the boarding date and time “9:00 on 2021/4/1”, the boarding section “A-B”, and the vehicle attribute information “for elderly people”.

(Boarding of Elderly Person)

The passenger U1 boards the vehicle 80-1 at a station “A” on the boarding date and time “9:00 on 2021/4/1”. The management system 3 carries out the management method S4. The vehicle-mounted apparatus 40-1 thus extracts a face image of the passenger U1 from an image captured by the camera 85-1. The vehicle-mounted apparatus 40-1 transmits, to the management server 30, the face image, the boarding information, and the vehicle attribute information relating to the vehicle 80-1. The management server 30 obtains the reservation information relating to the passenger U1 by recognizing the face image of the passenger U1. The management server 30 determines that the vehicle attribute information “for elderly people” included in the reservation information relating to the passenger U1 matches the vehicle attribute information “for elderly people” transmitted from the vehicle-mounted apparatus 40-1. The management server 30 also determines that the boarding station “A” is included in the boarding section “A-B” included in the reservation information. Therefore, the management server 30 transmits the permission information to the vehicle-mounted apparatus 40-1, and the vehicle-mounted apparatus 40-1 controls the door 80-1 to be open. Further, the management server 30 updates the reservation information relating to the passenger U1 so that the reservation information includes the boarding information.

Thereafter, the passenger U1 alights from the vehicle 80-1 at a station “B”. The management system 3 carries out the management method SS. The vehicle-mounted apparatus 40-1 thus extracts a face image of the passenger U1 from an image captured by the camera 85-1. The vehicle-mounted apparatus 40-1 transmits, to the management server 30, the face image and the alighting information. The management server 30 obtains the reservation information relating to the passenger U1 by recognizing the face image of the passenger U1, as in a case of boarding. The management server 30 also determines that the alighting station “B” is included in the boarding section “A-B” included in the reservation information relating to the passenger U1. Thus, the management server 30 transmits the permission information to the vehicle-mounted apparatus 40-1, and the vehicle-mounted apparatus 40-1 updates the reservation information relating to the passenger U1 so that the reservation information includes the alighting information, without outputting the error information.

Note that, in a case where the passenger U1 boards the vehicle 80-2 or 80-3 at the station A, the management server 30 determines that the vehicle attribute information “for elderly people” which is included in the reservation information relating to the passenger U1 does not match the vehicle attribute information “for family” or “for commute” which has been transmitted from the vehicle-mounted apparatus 40-1. Therefore, the management server 30 transmits the non-permission information to the vehicle-mounted apparatus 40-1, and the vehicle-mounted apparatus 40-1 controls the door 80-1 to be closed.

Also in a case where the passenger U1 boards the vehicle 80-1 at a station “C” which is not included in the boarding section “A-B”, the management server 30 determines that the boarding station “C” is not included in the boarding section “A-B”which is included in the reservation information relating to the passenger U1. Therefore, the management server 30 transmits the non-permission information to the vehicle-mounted apparatus 40-1, and the vehicle-mounted apparatus 40-1 controls the door 80-1 to be closed.

Also in a case where the passenger U1 boards the vehicle 80-1 at the station “A” and then alights from the vehicle 80-1 at a station “D” which is not included in the boarding section “A-B”, the management server 30 determines that the alighting station “D” is not included in the boarding section “A-B” which is included in the reservation information relating to the passenger U1. Therefore, the management server 30 transmits the non-permission information to the vehicle-mounted apparatus 40-1, and the vehicle-mounted apparatus 40-1 controls the door 80-1 to be closed.

The passenger U1 who is an “elderly person” can thus board the vehicle 80-1 “for elderly people” only with the face recognition in accordance with the reservation with respect to which payment has been performed with the senior discount, and receive the service for elderly people. Therefore, a level of satisfaction is improved.

(Reservation for Passenger with Child)

The passenger U2 reserves use of the vehicle 80-2 with use of the terminal 71. Specifically, the passenger U2 inputs, into the terminal 71, a face image, the passenger attribute information “with a child”, and an image including a maternal and child health handbook as a subject. The passenger U2 also inputs, into the terminal 71, the vehicle attribute information “for family”, the boarding date and time “10:00 on 2021/4/1”, and the boarding section “A-B”, as contents of a reservation. The management system 3 carries out the reservation method S3. The management server 30 thus determines that the certification information is appropriate, and, with respect to the passenger U2, the management server 30 registers the passenger information including the passenger ID “U2”, the face image, and the passenger attribute information “with a child”. Further, the management server 30 applies the discount information “discount for a passenger with a child” in accordance with a combination of the passenger attribute information “with a child” which is included in the passenger information relating to the passenger U2 and the vehicle attribute information “for family” which has been received as a content of the reservation from the terminal 71, and then performs payment. The management server 30 also issues the reservation ID “R002”, and registers the reservation information including the passenger ID “U2”, the boarding date and time “10:00 on 2021/4/1”, the boarding section “A-B”, and the vehicle attribute information “for family”.

(Boarding with Child)

Detailed examples of the management methods S4 and SS carried out when the passenger U2 boards and alights from the vehicles 80-1 to 80-3 are described substantially similarly by replacing, with “2”, “1” at the end of the reference sign in the detailed example of the “Boarding of elderly person” described above. Therefore, detailed descriptions are not repeated.

The passenger U2 who is “with a child” can thus board the vehicle 80-2 “for family” only with the face recognition in accordance with the reservation with respect to which payment has been performed with the parent-child discount, and receive the service for family. Therefore, a level of satisfaction is improved.

(Purchase of Commuter Ticket by Commuter)

The passenger U3 purchases a commuter ticket for use of the vehicle 80-3 with use of the terminal 71. Specifically, the passenger U3 inputs, into the terminal 71, a face image and the passenger attribute information “general”. The passenger U3 also inputs, into the terminal 71, the vehicle attribute information “for commute”, the effective period “2021/4/1 to 2021/9/30”, and the boarding section “X-Y”, as information relating to the commuter ticket. The management system 3 carries out the reservation method S3. The management server 30 thus registers, with respect to the passenger U3, the passenger information including the passenger ID “U3”, the face image, and the passenger attribute information “general”. Further, the management server 30 applies “normal fare” in accordance with a combination of the passenger attribute information “general” which is included in the passenger information relating to the passenger U3 and the vehicle attribute information “for commute” which has been received as the information relating to the commuter ticket from the terminal 71, and then performs payment. The management server 30 also issues the reservation ID “R003”, and registers the reservation information including the passenger ID “U3”, the effective period “2021/4/1 to 2021/9/30”, the boarding section “X-Z”, and the vehicle attribute information “for commute”.

(Boarding of Commuter with Commuter Ticket)

Detailed examples of the management methods S4 and SS carried out when the passenger U3 boards and alights from the vehicles 80-1 to 80-3 are described substantially similarly by replacing, with “3”, “1” at the end of the reference sign in the detailed example of the “Boarding of elderly person” described above. Therefore, detailed descriptions are not repeated.

The passenger U3 can thus board the vehicle 80-3 only with the face recognition during the effective period, in accordance with the information relating to the commuter ticket with respect to which payment has been performed with the normal fare. Therefore, a level of satisfaction is improved.

### Effects of the Present Example Embodiment

In the present example embodiment, the vehicle 80 is reserved with use of the face image of the passenger U, the passenger attribute information, and the vehicle attribute information desired by the passenger U, and the face recognition is carried out at a time of actual boarding and alighting. The passenger U can thus board, only with the face recognition at a time of boarding and alighting, the vehicle 80 which has been reserved, and receive the service which corresponds to the attribute of the vehicle 80, at the fare which corresponds to a combination of the attribute of the passenger U and the attribute of the vehicle 80 that has been reserved. Therefore, a level of satisfaction of the passenger is improved.

Further, with regard to (i) a composition of a train in which a plurality of vehicles 80 having different fare systems are mixed and (ii) a reduction of congestion, effects similar to those brought about in the third example embodiment are brought about. Furthermore, since the camera 85 provided at the doorway 82 has a ticket checking function, there is no need to install a ticket gate at a station. As a result, it is expected that people other than the passenger U of the vehicle 80 use a facility in the station, and an effect of an increase in profits is brought about.

### Fifth Example Embodiment

The following description will discuss, in detail, a fourth example embodiment of the present invention with reference to drawings. The present example embodiment includes (i) an embodiment which realizes setting of a fare which corresponds to an attribute of a passenger and an attribute of a vehicle, with use of an IC tag carried by the passenger who has made a reservation and (ii) an embodiment which realizes the setting of the fare with use of face recognition and without the need of a reservation.

<Configuration of Management System 4>

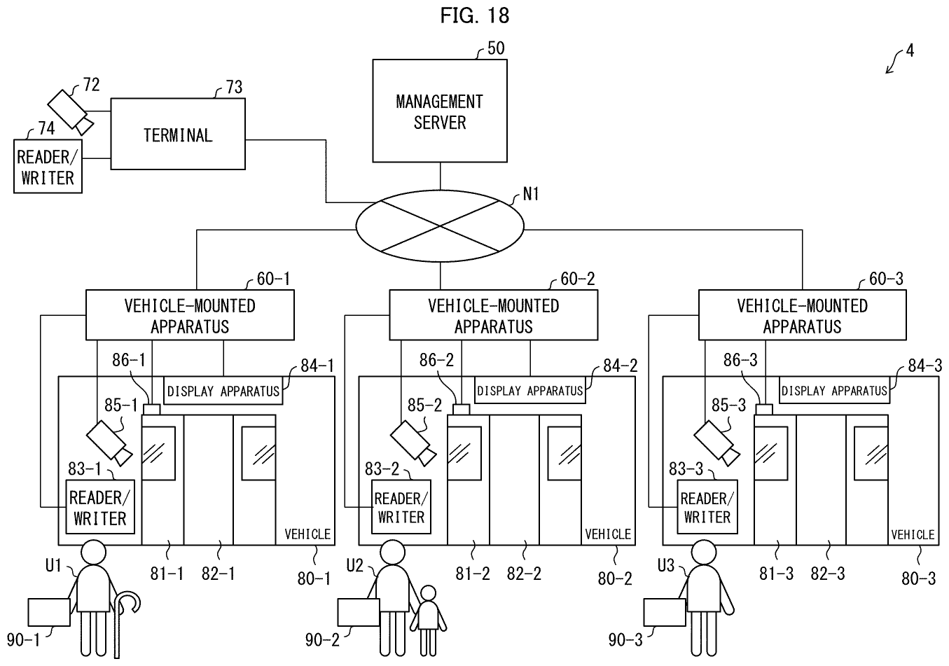

A configuration of a management system 4 in accordance with the present example embodiment is described with reference to FIG. 18. FIG. 18 is a block diagram illustrating the configuration of the management system 4. As illustrated in FIG. 18, the management system 4 includes a management server 50, a terminal 73, vehicle-mounted apparatuses 60-1 to 60-3, reader/writers 83-1 to 83-3, cameras 85-1 to 85-3, opening and closing apparatuses 86-1 to 86-3, and display apparatuses 84-1 to 84-3. The vehicle-mounted apparatus 60-1, the reader/writer 83-1, the camera 85-1, the opening and closing apparatus 86-1, and the display apparatus 84-1 are provided to a vehicle 80-1. The vehicle-mounted apparatus 60-2, the reader/writer 83-2, the camera 85-2, the opening and closing apparatus 86-2, and the display apparatus 84-2 are provided to a vehicle 80-2. The vehicle-mounted apparatus 60-3, the reader/writer 83-3, the camera 85-3, the opening and closing apparatus 86-3, and the display apparatus 84-3 are provided to a vehicle 80-3. The reader/writers 83, the display apparatuses 84, the vehicles 80, doors 81, doorways 82, passengers U, and IC tags 90 are as described in the third example embodiment. The cameras 85 and the opening and closing apparatuses 86 are as described in the fourth example embodiment. The management server 50, the vehicle-mounted apparatuses 60-1 to 60-3, and the terminal 73 are communicably connected to each other via a network N1. Detailed examples of the network N1 are as described in the fourth example embodiment. Note that FIG. 18 illustrates a single management server 50 and a single terminal 73, but this does not limit the numbers of these apparatuses included in the present example embodiment.

(Configuration of Terminal 73)

The terminal 73 is a computer operated by the passenger U. The terminal 73 functions as a terminal on which a reservation service and a passenger registration service which are provided by the management server 50 is used. In the present example embodiment, the IC tag 90 of the passenger U is used in the reservation service. In the passenger registration service, a face image of the passenger U is used. Specifically, an input apparatus, a display apparatus, a camera 72, and a reader/writer 74 are connected to the terminal 73. Alternatively, a part or all of the input apparatus, the display apparatus, the camera 72, and the reader/writer 74 may be embedded in the terminal 73. The terminal 73 displays, on the display apparatus, information received from the management server 50. The terminal 73 transmits, to the management server 50, information obtained via the input apparatus, the camera 72, or the reader/writer 74.

(Configuration of Management Server 50)

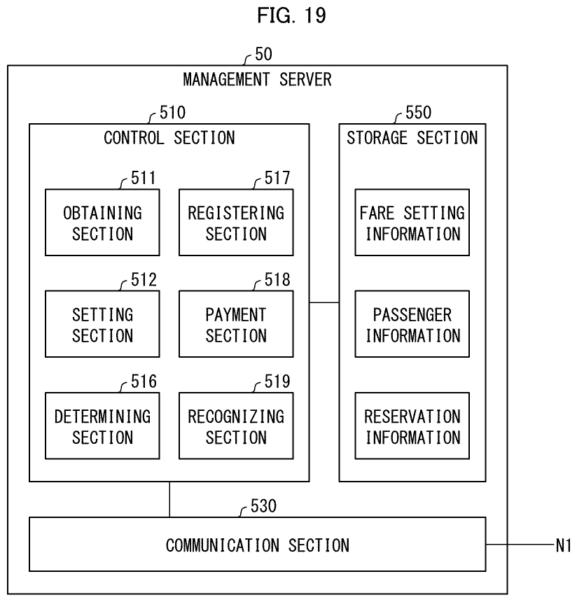

The management server 50 is an example of a configuration realizing at least a part of the “management apparatus” recited in the claims. A configuration of the management server 50 is described with reference to FIG. 19. FIG. 19 is a block diagram illustrating the configuration of the management server 50. As illustrated in FIG. 19, the management server 50 includes a control section 510, a storage section 550, and a communication section 530. The control section 510 includes an obtaining section 511, a setting section 512, a determining section 516, a registering section 517, a payment section 518, and a recognizing section 519. The storage section 550 includes fare setting information, passenger information, and reservation information.

The determining section 516, the payment section 518, the recognizing section 519, and the communication section 530 are configured similarly to respective functional blocks having the same names in the fourth example embodiment. The fare setting information is as described with reference to FIG. 7 in the third example embodiment. A configuration different from that in the fourth example embodiment is described below.

The registering section 517 receives, from the terminal 73, information for use of the reservation service in which the IC tag 90 is used, and registers the reservation information. The registering section 517 also receives, from the terminal 73, information for use of the passenger registration service in which the face image is used, and registers the passenger information. The passenger information and the reservation information to be registered are different, in detail, from the passenger information and the reservation information in the fourth example embodiment. Details of these pieces of information are described later.

In a case where the passenger U who has used the reservation service has been detected in a vicinity of the doorway 82, the obtaining section 511 obtains a passenger ID of the passenger U and vehicle attribute information by receiving the passenger ID and the vehicle attribute information from the vehicle-mounted apparatus 60. The obtaining section 511 also obtains passenger attribute information associated with the passenger ID by referring to the passenger information.

In a case where the passenger U who has used the passenger registration service has been detected in the vicinity of the doorway 82, the obtaining section 511 obtains a face image of the passenger U and the vehicle attribute information by receiving the face image and the vehicle attribute information from the vehicle-mounted apparatus 60. In a case where face recognition in which the received face image and the registered passenger information are used is successful, the obtaining section 511 also obtains the passenger attribute information included in the passenger information.

The setting section 512 sets a fare in accordance with a combination of vehicle attribute information and the passenger attribute information in the reservation service. In a case where the passenger U who has used the passenger registration service has been detected in the vicinity of the doorway 82, the setting section 512 sets the fare, in accordance with boarding information, alighting information, and a combination of the vehicle attribute information and the passenger attribute information.

(Reservation Information)

The reservation information is information indicative of a reservation which has been made with use of the IC tag 90. The reservation information is configured substantially similarly to the reservation information described with reference to FIG. 13 in the fourth example embodiment. Note, however, that the reservation information in the present example embodiment differs in that the reservation information includes a tag ID of the IC tag 90, instead of the passenger ID.

(Passenger Information)

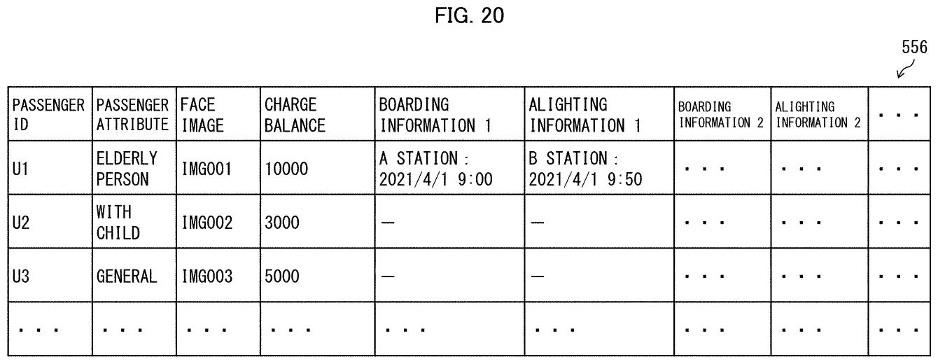

The passenger information is information indicative of the passenger U. The passenger information is described with reference to FIG. 20. FIG. 20 is a drawing illustrating an example of a configuration of the passenger information. As illustrated in FIG. 20, the passenger information includes the passenger ID, a passenger attribute, the face image, a charge balance, boarding information i (i=1, 2, . . . ), and alighting information i. The passenger ID, the passenger attribute, and the face image are each information determined at a time of registration of the passenger information. The charge balance is information determined at the time of registration of the passenger information and at a time of update of the passenger information. The boarding information i and the boarding information i are information determined at a time of boarding and alighting of the passenger U, and indicate a boarding history of the passenger U. In a case where the passenger information already includes boarding information 1 to k (k=1, 2, . . . ) and alighting information 1 to k, the passenger information is updated so as to include boarding information k+1 and alighting information k+1, in accordance with boarding and alighting of the passenger U. Hereinafter, updating the passenger information so that the passenger information includes the passenger information k+1 or the alighting information k+1 is also referred to as simply “updating the passenger information so that the passenger information includes the passenger information or the alighting information”.

(Configuration of Vehicle-Mounted Apparatus 60)

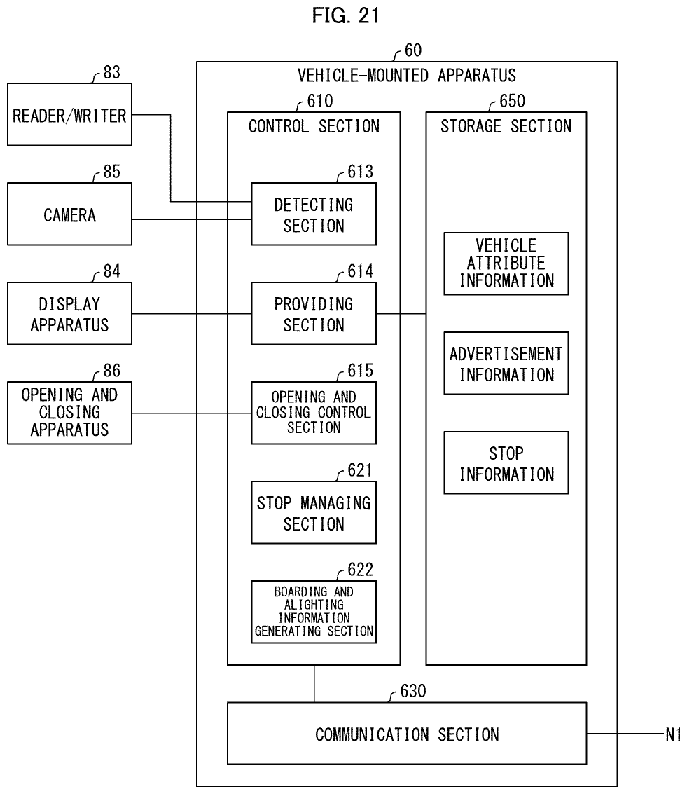

The vehicle-mounted apparatus 60 is an example of a configuration realizing at least a part of the “management apparatus” recited in the claims. A configuration of the vehicle-mounted apparatus 60 is described with reference to FIG. 21. FIG. 21 is a block diagram illustrating the configuration of the vehicle-mounted apparatus 60. As illustrated in FIG. 21, the vehicle-mounted apparatus 60 includes a control section 610, a storage section 650, and a communication section 630. The control section 610 includes a detecting section 613, a providing section 614, an opening and closing control section 615, a stop managing section 621, and a boarding and alighting information generating section 622. The storage section 650 stores therein the vehicle attribute information, advertisement information, and stop information. The providing section 614, the opening and closing control section 615, the stop managing section 621, the boarding and alighting information generating section 622, and the communication section 630 are configured similarly to respective functional blocks having the same names in the fourth example embodiment. The vehicle attribute information, the advertisement information, and the stop information are as described in the fourth example embodiment. A configuration different from that in the fourth example embodiment is described below.

The detecting section 613 detects the passenger U by extracting the face image from an image captured by the camera 85. The detecting section 613 also detects the passenger by reading, with use of the reader/writer 83, information stored in the IC tag 90.

<Flow of Reservation Method S6 in which IC Tag 90 is Used>

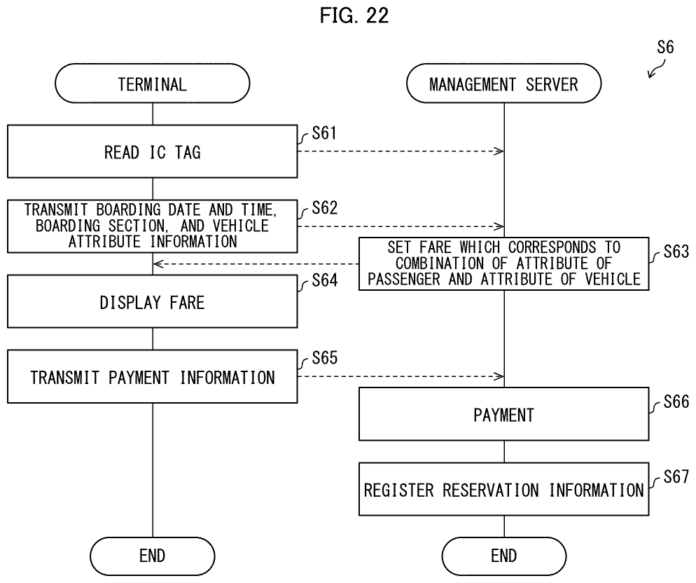

A flow of a reservation method S6 carried out in the reservation service by the management system 4 configured as described above is described with reference to FIG. 22. FIG. 22 is a flowchart illustrating the flow of the reservation method S6 in which the IC tag 90 is used. As illustrated in FIG. 22, the management method S6 includes steps S61 to S67.

(Step S61)

In the step S61, the terminal 73 obtains information stored in the IC tag 90 with use of the reader/writer 74, and transmits the information to the management server 50. The information read from the IC tag 90 includes a tag ID and passenger attribute information.

(Step S62)

In the step S62, the terminal 73 obtains boarding date and time, a boarding section, and vehicle attribute information, and transmits the boarding date and time, the boarding section, and the vehicle attribute information to the management server 50. For example, the terminal 73 may obtain these pieces of information which are inputted with use of the input apparatus.

(Steps S63 to S67)

Processes in the steps S63 to S67 are substantially similar to the processes in the steps S34 to S38 in the fourth example embodiment. The management system 4 thus sets a fare which corresponds to a combination of the passenger attribute information and the vehicle attribute information, on the basis of the boarding date and time, the boarding section, the vehicle attribute information, and the passenger attribute information received from the terminal 73. The management system 4 performs payment of the set fare, and registers reservation information. Note, however, that the registering section 517 differs from a corresponding section in the fourth example embodiment in that the registering section 517 registers the reservation information which includes the tag ID, instead of a passenger ID.

<Flow of Management Method S7 at a Time of Boarding>

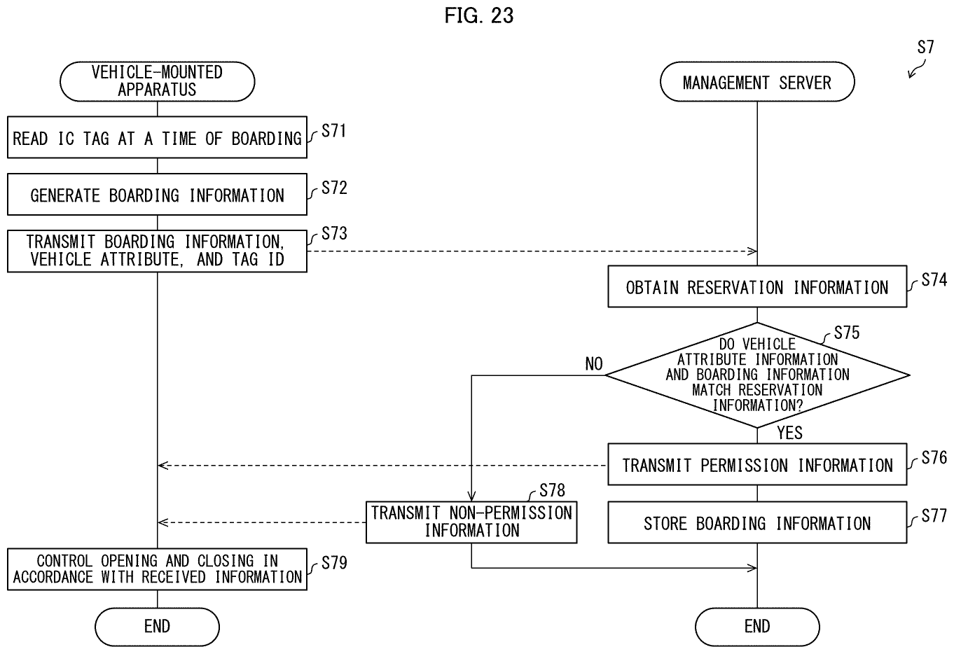

A flow of a management method S7 carried out by the management system 4 is described with reference to FIG. 23. FIG. 23 is a flowchart illustrating the flow of the management method S7 which is carried out when the passenger U who has made a reservation with use of the IC tag 90 boards the vehicle 80. As illustrated in FIG. 23, the management method S7 includes steps S71 to S79.

(Step S71)

In the step S71, the detecting section 613 of the vehicle-mounted apparatus 60 detects the passenger U who boards the vehicle 80, by reading the information from the IC tag 90 with use of the reader/writer 83. The information read from the IC tag 90 includes the tag ID.

(Step S72)

In the step S72, the boarding and alighting information generating section 622 generates boarding information. Details of this step are as described in connection with the step S42 in the fourth example embodiment.

(Step S73)

In the step S73, the detecting section 613 transmits, to the management server 50, the boarding information which has been generated in the step S72, vehicle attribute information which is stored in the storage section 650, and the tag ID which has been obtained in the step S71.

(Step S74)

In the step S74, the determining section 516 obtains the reservation information including the tag ID received from the vehicle-mounted apparatus 60.

(Step S75)

Processes in the steps S75 to S79 are substantially similar to the processes in the steps S46 to S50 described in the fourth example embodiment. Thus, in a case where the vehicle attribute information and the boarding information received from the vehicle-mounted apparatus 60 matches the reservation information, the management system 4 controls the door 81 to be open. In a case where the vehicle attribute information and the boarding information do not match the reservation information, the management system 4 controls the door 81 to be closed.

<Flow of Management Method S8 at a Time of Alighting>

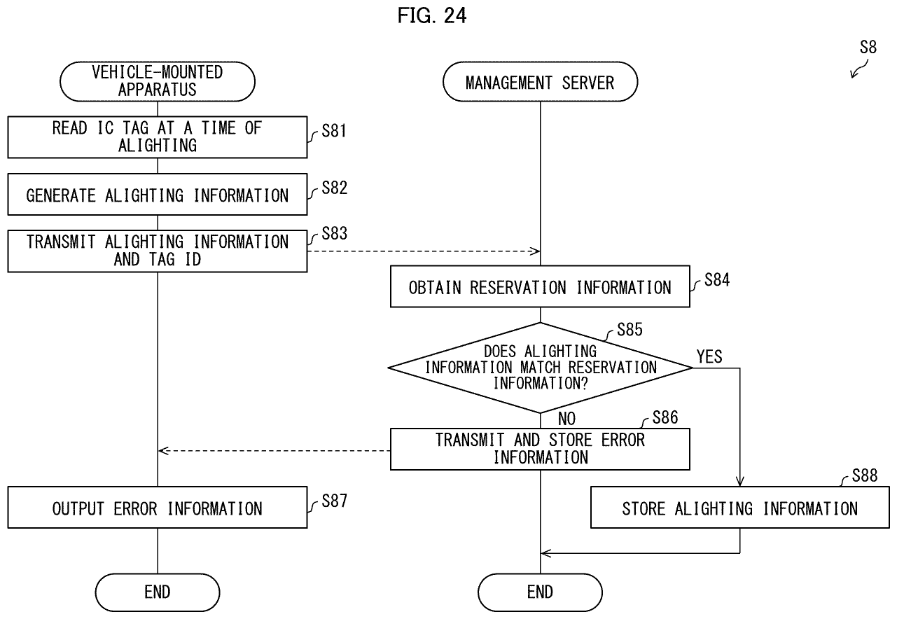

A flow of a management method S8 carried out by the management system 4 is described with reference to FIG. 24. FIG. 24 is a flowchart illustrating the flow of the management method S8 which is carried out when the passenger U who has made the reservation with use of the IC tag 90 alights from the vehicle 80. As illustrated in FIG. 24, the management method S8 includes steps S81 to S88.

(Step S81)

In the step S81, the detecting section 613 of the vehicle-mounted apparatus 60 detects the passenger U who boards the vehicle 80, by reading the information from the IC tag 90 with use of the reader/writer 83. The information read from the IC tag 90 includes the tag ID.

(Step S82)

In the step S82, the boarding and alighting information generating section 622 generates alighting information. Details of this step are as described in connection with the step S52 in the fourth example embodiment.

(Step S83)

In the step S83, the detecting section 613 transmits, to the management server 50, the alighting information which has been generated in the step S82 and the tag ID which has been obtained in the step S81.

(Step S84)

In the step S84, the determining section 516 obtains the reservation information including the tag ID received from the vehicle-mounted apparatus 60.

(Step S85)

Processes in the steps S85 to S88 are substantially similar to the processes in the steps S56 to S59 described in the fourth example embodiment. Thus, in a case where the alighting information received from the vehicle-mounted apparatus 60 matches the reservation information, the management system 4 stores the alighting information. In a case where the alighting information does not match the reservation information, the management system 4 transmits error information to the vehicle-mounted apparatus 60, and also stores the error information in the management server 50.

<Flow of Registration Method S9>

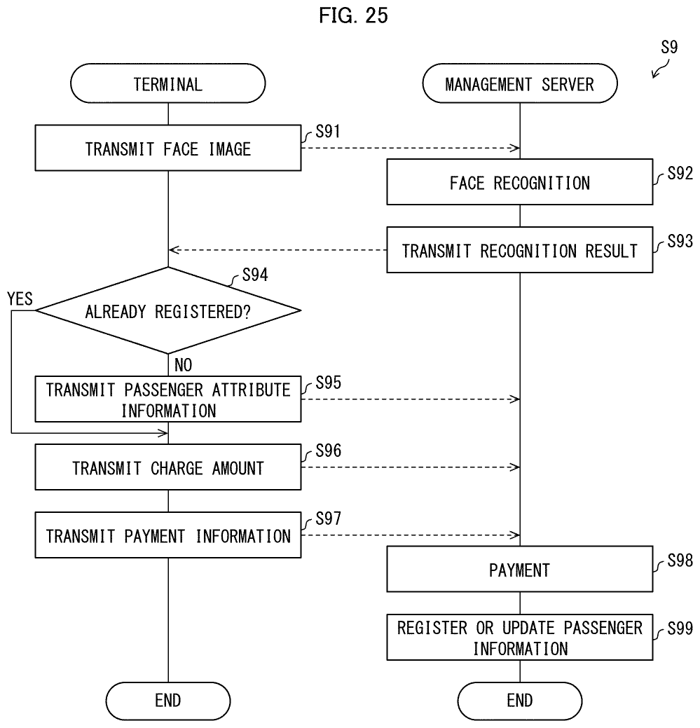

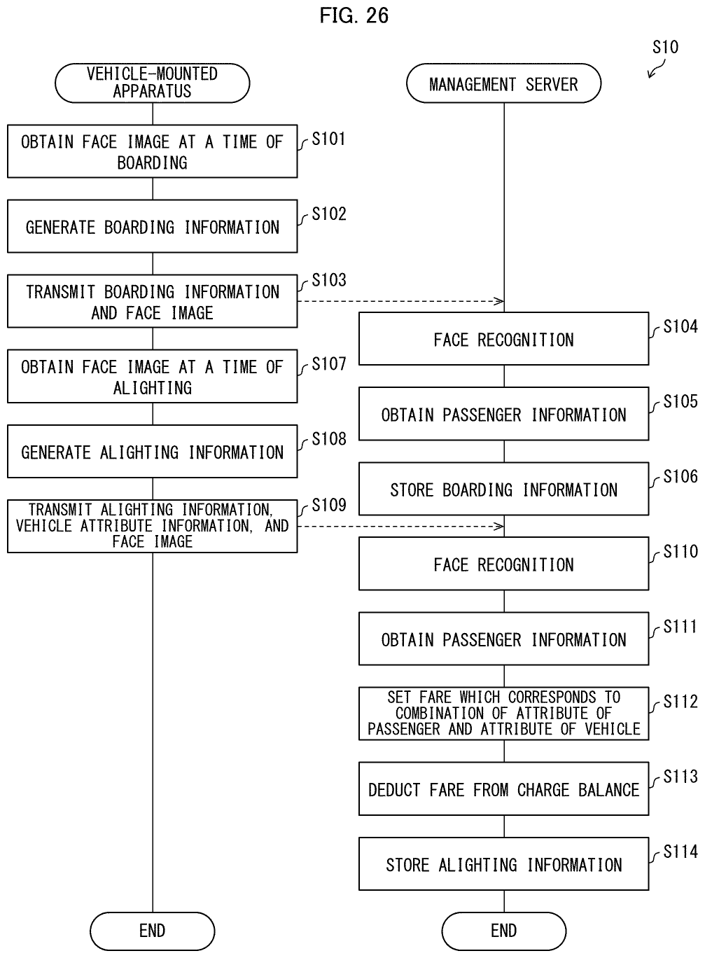

A flow of a registration method S9 carried out in the registration service by the management system 4 is described with reference to FIG. 25. FIG. 25 is a flowchart illustrating the flow of the registration method S9 which is carried out in advance for face recognition at a time of boarding and alighting. As illustrated in FIG. 25, the registration method S9 includes steps S91 to S99.

(Step S91)

In the step S91, the terminal 71 extracts a face image of the passenger U from an image captured by the camera 72, and transmits the extracted face image to the management server 50.

(Step S92)

In the step S92, the recognizing section 519 of the management server 50 carries out face recognition with use of the received face image. Specifically, in a case where the recognizing section 519 can determine that the received face image and a face image included in passenger information stored in the storage section 550 indicates an identical person, the recognizing section 519 determines that the face recognition has succeeded.

(Step S93)

In the step S93, in a case where the recognition has succeeded, the recognizing section 519 obtains, from the storage section 550, the passenger information including the face image which has been determined to indicate an identical person. The recognizing section 519 transmits, to the terminal 73, this recognition result which indicates whether or not the face recognition has succeeded.

(Step S94)

In the step S94, the terminal 73 determines whether or not the passenger information relating to the passenger U is already registered. Specifically, in a case where the recognition result received from the management server 50 indicates success, the terminal 73 determines that the passenger information is already registered. In a case where the recognition result indicates a failure, the terminal 73 determines that the passenger information is not registered.

(YES in Step S94)

In a case where it is a determination of YES is made in the step S94, the terminal 73 carries out the step S96 without carrying out the next step S95.

(NO in step S94: step S95)

In a case where a determination of NO is made in the step S95, the terminal 73 obtains the passenger attribute information indicative of the attribute of the passenger U, and transmits the passenger attribute information to the management server 50, in the step S95. The terminal 73 may further obtain the above-described certification information in addition to the passenger attribute information, and transmit the certification information to the management server 50. Details of the certification information are as described in the fourth example embodiment.

(Step S96)

In the step S96, the terminal 73 obtains information indicative of a charge amount, and transmits the information to the management server 50. For example, the terminal 73 may obtain the information indicative of the charge amount via the input apparatus.

(Step S97)

In the step S97, the terminal 73 obtains payment information, and transmits the payment information to the management server 50. For example, the terminal 73 may obtain the payment information via the input apparatus. Details of the payment information are as described in the fourth example embodiment.

(Step S98)

In the step S98, the payment section 518 of the management server 50 performs payment with use of the received payment information.

(Step S99)

In the step S99, the registering section 517 registers or updates the passenger information.

Here, a case where the passenger information is not registered is described. In this case, the registering section 517 stores new passenger information including a passenger ID, the passenger attribute information, the face image, and a charge balance. As the passenger ID, a newly issued ID is applied. As the passenger attribute information and the face image, these pieces of information received from the terminal 73 are applied. As the charge balance, the charge amount received from the terminal 73 is applied. Note that, in a case where the certification information is received from the terminal 73, the registering section 517 may determine whether or not the received passenger attribute information is appropriate, with reference to the certification information. In this case, in a case where the registering section 517 determines that the passenger attribute information is appropriate, the registering section 517 registers the passenger information. In a case where the registering section 517 determines that the passenger attribute information is not appropriate, the registering section 517 ends the registration method S9.

A case where the passenger information is already registered is described. In this case, the registering section 517 adds the charge amount received from the terminal 73 to the charge balance included in the passenger information relating to the passenger who succeeded in the face recognition, and thereby calculates a new charge balance. The registering section 517 also updates the charge balance included in the registered passenger information to the new charge balance.

<Flow of Management Method S10 at a Time of Boarding and Alighting>

A flow of a management method S10 carried out by the management system 4 is described with reference to FIG. 26. FIG. 26 is a flowchart illustrating the flow of the management method S10 which is carried out at a time of boarding and alighting of the passenger U whose face image has been registered in advance. As illustrated in FIG. 26, the management method S10 includes steps S101 to S114.

(Step S101)

In the step S101, the detecting section 613 of the vehicle-mounted apparatus 60 detects the passenger who boards the vehicle 80, by extracting a face image of the passenger U from an image captured by the camera 85.

(Step S102)

In the step S102, the boarding and alighting information generating section 622 generates boarding information. Details of this step are as described in connection with the step S42 in the fourth example embodiment.

(Step S103)

In the step S103, the detecting section 613 transmits, to the management server 50, the boarding information which has been generated in the step S102 and the face image which has been obtained in the step S101.

(Step S104)

In the step S104, the recognizing section 519 of the management server 50 carries out face recognition with use of the received face image. Details of this step are as described in connection with the step S44 in the fourth example embodiment. Note that, in a case where the face recognition is not successful, the management server 50 ends the management method S10.

(Step S105)

In the step S105, the setting section 512 obtains, from the storage section 550, the passenger information which relates to the passenger U and which includes the passenger ID that has succeeded in the face recognition.

(Step S106)

In the step S106, the setting section 512 updates the passenger information relating to the passenger U so that the passenger information includes the boarding information received from the vehicle-mounted apparatus 60.

(Step S107)

In the step S107, the detecting section 613 of the vehicle-mounted apparatus 60 detects the passenger who alights from the vehicle 80, by extracting a face image of the passenger U from an image captured by the camera 85.

(Step S108)

In the step S108, the boarding and alighting information generating section 622 generates alighting information. Details of this step are as described in connection with the step S52 in the fourth example embodiment.

(Step S109)

In the step S109, the detecting section 613 transmits, to the management server 50, the alighting information which has been generated in the step S108 and the face image which has been obtained in the step S107.

(Step S110)

In the step S110, the recognizing section 519 carries out face recognition with use of the received face image. Details of this step are as described in connection with the step S44. Note that, in a case where the face recognition is not successful, the management server 50 ends the management method S10.

(Step S111)

In the step S111, the setting section 512 obtains the passenger information which relates to the passenger U and which includes the passenger ID that has succeeded in the face recognition. The obtained passenger information includes the boarding information relating to the passenger U.

(Step S112)

In the step S112, the setting section 512 sets a fare with reference to (i) the latest boarding information and the passenger attribute information which are included in the passenger information and (ii) the alighting information and the vehicle attribute information which have been received from the vehicle-mounted apparatus 60. Specifically, the setting section 512 calculates a normal fare in accordance with a given fare rule on the basis of a boarding station indicated by the boarding information and an alighting station indicated by the alighting information. The setting section 512 also refers to fare setting information, and obtains discount information associated with a combination of the vehicle attribute information and the passenger attribute information. The setting section 512 then sets the fare which is obtained by applying the discount information to the normal fare.

(Step S113)

In the step S113, the setting section 512 deducts the fare from the charge balance included in the passenger information, and calculates a new charge balance 934.

(Step S114)

In the step S114, the setting section 512 updates the passenger information so that the passenger information includes the alighting information and the new charge balance 934.

### Third Detailed Example

In the present example embodiment, a detailed example in which a reservation and boarding are made with use of the IC tag 90 is described. Here, the attributes of the vehicles 80-1 to 80-3 are respectively “for elderly people”, “for family” and “for commute”, similarly to the detailed examples of the third example embodiment. The passengers U1 to U3 are respectively an elderly person, a passenger with a child, and a commuter, similarly to the detailed examples of the third example embodiment.

Here, in particular, the passenger U1 is described as an example.

(Reservation for Elderly Person)

The passenger U1 reserves use of the vehicle 80-1 with use of the terminal 73. Specifically, the passenger U1 causes the reader/writer 74 to read the IC tag 90-1 in which the passenger attribute information “elderly person” is stored. The passenger U1 also inputs, into the terminal 73, the vehicle attribute information “for elderly people”, the boarding date and time “9:00 on 2021/4/1”, and the boarding section “A-B”, as contents of a reservation. The management system 4 carries out the reservation method S6. The management server 50 thus registers, with respect to the passenger U1, the passenger information including the tag ID and the passenger attribute information “elderly person”. Further, the management server 50 applies the discount information “senior discount” in accordance with a combination of the passenger attribute information “elderly person” which is included in the passenger information relating to the passenger U1 and the vehicle attribute information “for elderly people” which has been received as a content of the reservation from the terminal 73, and then performs payment. The management server 50 also issues the reservation ID “R001”, and registers the reservation information including the tag ID, the boarding date and time “9:00 on 2021/4/1”, the boarding section “A-B”, and the vehicle attribute information “for elderly people”.

(Boarding of Elderly Person)

The passenger U1 boards the vehicle 80-1 at a station “A” on the boarding date and time “9:00 on 2021/4/1”. The management system 4 carries out the management method S7. The vehicle-mounted apparatus 60-1 thus reads the tag ID from the IC tag 90-1 with use of the reader/writer 83, and transmits the tag ID to the management server 50. The management server 50 obtains the reservation information which relates to the passenger U1 and which includes the tag ID. The management server 50 determines that the vehicle attribute information “for elderly people” included in the reservation information relating to the passenger U1 matches the vehicle attribute information “for elderly people” transmitted from the vehicle-mounted apparatus 60-1. The management server 50 also determines that the boarding station “A” is included in the boarding section “A-B” included in the reservation information. Therefore, the management server 50 transmits the permission information to the vehicle-mounted apparatus 60-1, and the vehicle-mounted apparatus 60-1 controls the door 81-1 to be open. Further, the management server 50 updates the reservation information relating to the passenger U1 so that the reservation information includes the boarding information.

Thereafter, the passenger U1 alights from the vehicle 80-1 at a station “B”. The management system 4 carries out the management method S8. The vehicle-mounted apparatus 60-1 thus extracts a face image of the passenger U1 from an image captured by the camera 85-1. The vehicle-mounted apparatus 60-1 transmits, to the management server 50, the face image and the alighting information. The management server 50 obtains the reservation information relating to the passenger U1 by recognizing the face image of the passenger U1, as in a case of boarding. The management server 50 also determines that the alighting station “B” is included in the boarding section “A-B” included in the reservation information relating to the passenger U1. Thus, the management server 50 transmits the permission information to the vehicle-mounted apparatus 60-1, and the vehicle-mounted apparatus 60-1 updates the reservation information relating to the passenger U1 so that the reservation information includes the alighting information, without outputting the error information.

Note that detailed examples of the management methods S7 and S8 which are carried out when the passenger U1 boards and alights from the vehicles 80-1 to 80-3 are substantially similar to the detailed example of the “Boarding of elderly person” in the above-described second detailed example. Therefore, detailed descriptions are not repeated.

The passenger U1 who is an “elderly person” can thus board the vehicle 80-1 “for elderly people” only by carrying the IC tag 90 used for the reservation, in accordance with the reservation with respect to which payment has been performed with the senior discount, and receive the service for elderly people. Therefore, a level of satisfaction of the passenger U1 is improved.

### Fourth Detailed Example

In the present example embodiment, a detailed example in which the passenger U boards the vehicle 80 with use of a face image and without making a reservation is described. Here, the attributes of the vehicles 80-1 to 80-3 are respectively “for elderly people”, “for family” and “for commute”, similarly to the detailed examples of the third example embodiment. The passengers U1 to U3 are respectively an elderly person, a passenger with a child, and a commuter, similarly to the detailed examples of the third example embodiment.

Here, in particular, the passenger U2 is described as an example.

(Pre-Registration of Passenger with Child)

The passenger U2 registers the passenger information in advance with use of the terminal 73. Specifically, the passenger U2 inputs, into the terminal 73, a face image, the passenger attribute information “with a child”, and an image including a maternal and child health handbook as a subject. The passenger U2 also inputs the charge amount and the payment information into the terminal 73. The management system 4 carries out the registration method S9. The management server 50 thus determines that the certification information is appropriate, and, with respect to the passenger U2, the management server 50 registers the passenger information including the passenger ID “U2”, the face image, the passenger attribute information “with a child”, and the charge balance.

(Boarding with Child)

In a case where the passenger U2 boards the vehicle 80-2, the management system 4 carries out the management method S10. The vehicle-mounted apparatus 60-2 thus extracts a face image of the passenger U2 from an image captured by the camera 85-2. The vehicle-mounted apparatus 60-2 transmits, to the management server 50, the face image and the boarding information. The management server 50 obtains the passenger information relating to the passenger U2 by recognizing the face image of the passenger U2, and updates the passenger information so that the passenger information includes the boarding information.

Thereafter, when the passenger U2 alights from the vehicle 80-2, the vehicle-mounted apparatus 60-2 extracts a face image of the passenger U2 from an image captured by the camera 85-2. The vehicle-mounted apparatus 60-2 transmits, to the management server 50, the face image, the alighting information, and the vehicle attribute information “for family” relating to the vehicle 80-2. The management server 50 obtains the passenger information relating to the passenger U2 by recognizing the face image of the passenger U2, and obtains the passenger attribute information “with a child” included in the passenger information. Thus, the management server 50 deducts, from the charge balance, the fare which is obtained by applying the discount information “parent-child discount” which corresponds to a combination of the vehicle attribute information “for family” and the passenger attribute information “with a child”. The management server 50 updates the passenger information relating to the passenger U2 so that the passenger information includes the charge balance after the deduction and the alighting information.

The passenger U2 who is “with a child” can thus board the vehicle 80-2 “for a family” only with the face recognition and without the need of making a reservation, by registering the face image in advance, and receive the service for family at the fare with the parent-child discount. Therefore, a level of satisfaction is improved.

### Effects of the Present Example Embodiment

In the present example embodiment, the vehicle 80 having the vehicle attribute information desired by the passenger U is reserved with use of the IC tag 90 in which the passenger attribute information relating to the passenger U is stored. Then, it is determined whether or not the vehicle 80 which the passenger U has actually boarded matches the reservation information, with use of the IC tag 90 carried by the passenger U. The passenger U can thus board the vehicle 80 which has been reserved, only by carrying the IC tag 90 used for the reservation. Then, the passenger U can receive the service which corresponds to the attribute of the vehicle 80, at the fare which corresponds to a combination of the attribute of the passenger U and the attribute of the vehicle 80 that has been reserved. Therefore, a level of satisfaction of the passenger U is improved.

Further, in the present example embodiment, the face image of the passenger U and the passenger attribute information are registered in advance as the passenger information, and the face recognition is carried out at a time of actual boarding and alighting. The passenger U can thus board the vehicle 80 without making a reservation in advance and only with the face recognition at a time of boarding and alighting. Then, the passenger U can receive the service which corresponds to the attribute of the vehicle 80, at the fare which corresponds to a combination of the attribute of the passenger U and the attribute of the vehicle 80 that has been reserved. Therefore, a level of satisfaction of the passenger is improved.

Further, with regard to (i) a composition of a train in which a plurality of vehicles 80 having different fare systems are mixed, (ii) a reduction of congestion, and (iii) an increase in profits, effects similar to those brought about in the third or fourth example embodiment are brought about.

[Modifications]

(Modification of Biometric Information)

In each of the fourth and fifth example embodiments, an example has been described in which the detecting section 413, 613 detects the passenger U by reading the face image as biometric information relating to the passenger U. The detecting section 413, 613 is not limited to this example, and may detect the passenger U by reading another biometric information such as an iris, a fingerprint, or a vein. In this case, the management server 30, 50 stores the passenger information including the corresponding biometric information.

(Modification of Vehicle)

In each example embodiment, an example has been described in which the plurality of vehicles 80 constitute a composition of a train. The plurality of vehicles 80 are not limited to this example, and may be, for example, vehicles operated as different units. For example, the plurality of vehicles 80 may be each a vehicle of a route bus or a taxi.

(Modification of Operator of Terminal)

In each of the fourth and fifth example embodiments, the terminal 71, 73 has been described as a computer which is operated by the passenger U. The terminal 71, 73 is not limited this example, and may be a computer operated by an operator at a window. In this case, the terminal 71, 73 may not transmit the certificate information to the management server 30, 50, in a case where the certifying document presented to the operator by the passenger U is appropriate.

(Reader/Writers or Cameras for Boarding and Alighting)

In each of the third to fifth example embodiments, a single reader/writer 83 or a single camera 85 is illustrated for a single doorway 82. A plurality of reader/writers 83 or a plurality of cameras 85 may be installed for a single doorway 82. For example, a reader/writer 83 for boarding and a reader/writer 83 for alighting may be installed for a single doorway 82. Further, for example, a camera 85 that has a lens directed in a direction in which the camera 85 can capture an image of the passenger U who boards the vehicle 80 and a camera 85 that has a lens directed in a direction in which the camera 85 can capture an image of the passenger U who alights from the vehicle 80 may be installed for a single doorway 82.

(Doorways for Boarding and Alighting)

Further, in each of the third to fifth example embodiments, the doorway 82 has been described as being used at a time of boarding and at a time of alighting. The vehicle 80 may include a doorway 82 for boarding and a doorway 82 for alighting.

(Modification of Providing Section)

In each of the third to fifth example embodiments, the providing section 414, 614 may output another information corresponding to the vehicle attribute information to another output apparatus, instead of or in addition to displaying the advertisement information on the display apparatus 84. For example, the providing section 414 may output a voice corresponding to the vehicle attribute information to a speaker.

(Modification of Determining Section)

Further, in each of the third to fifth example embodiments, the determining section 316, 516 has been described as controlling opening and closing of the door 81, in accordance with the determination result of whether or not the boarding information and the vehicle attribute information match the reservation information. The determining section 316, 516 is not limited to this example, and may carry out another process which corresponds to the determining result. For example, the determining section 316, 516 may display the determining result on the display apparatus installed in the vicinity of the doorway 82. The determining section 316, 516 may determine an additional fee, in a case where the additional fee to be collected from the passenger occurs depending on the determination result.

(Omission of Process at a Time of Alighting)

Further, in each of the fourth and fifth example embodiments, the management system 3, 4 may not carry out the management method S5, S8 which is carried out at a time of alighting, in a case where the passenger U who has made a reservation boards the vehicle 80.

(Modification of Disposition of Each Function Block)

The functional blocks included in the management server 30, and 50 may be dispersed and disposed in a plurality of servers. For example, the functional blocks may be dispersed and disposed in a management server which has at least the setting section 312, 512, a registration server which has at least the registering section 317, 517, and a recognition server which has at least the recognizing section 319, 519.

In each of the fourth and fifth example embodiments, a part or all of the functional blocks included in the vehicle-mounted apparatus 40, 60 may be included in the management server 30, 50. A part or all of the functional blocks included in the management server 30, 50 may be included in the vehicle-mounted apparatus 40, 60.

### Software Implementation Example

A part or all of the functions of each of the management apparatuses 100A and 100B, the vehicle-mounted apparatuses 20, 40, and 60, and the management servers 30 and 50 may be realized by hardware such as an integrated circuit (IC chip) or may be alternatively realized by software.

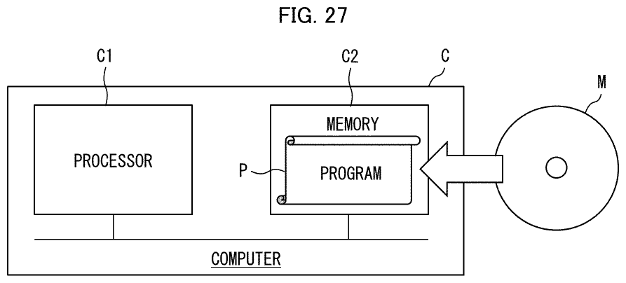

In the latter case, the management apparatuses 100A and 100B, the vehicle-mounted apparatuses 20, 40, and 60, and the management servers 30 and 50 are each realized by, for example, a computer that executes instructions of a program that is software realizing the functions. FIG. 27 illustrates an example of such a computer (hereinafter, referred to as “computer C”). The computer C includes at least one processor C1 and at least one memory C2. In the memory C2, a program P for causing the computer C to operate as each of the management apparatuses 100A and 100B, the vehicle-mounted apparatuses 20, 40, and 60, and the management servers 30 and 50 is recorded. In the computer C, the functions of each of the management apparatuses 100A and 100B, the vehicle-mounted apparatuses 20, 40, and 60, and the management servers 30 and 50 are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via such a recording medium M. The program P can also be transmitted via a transmission medium. Such a transmission medium can be, for example, a communication network, a broadcast wave, or the like. The computer C can acquire the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as follows. Note, however, that the present invention is not limited to the following example aspects.

(Supplementary Note 1)

A management apparatus including:
a detecting means for detecting a passenger in a vicinity of a doorway of at least any vehicle included in a plurality of vehicles;
an obtaining means for obtaining (i) information indicative of an attribute of the passenger who has been detected by the detecting means and (ii) information indicative of an attribute of the at least any vehicle having the doorway in which the passenger has been detected; and
a setting means for setting a fare to be collected from the passenger, in accordance with a combination of the attribute of the passenger and the attribute of the at least any vehicle.

With the above configuration, a fare is set in accordance with a combination of an attribute of a passenger and an attribute of a vehicle which is included in a plurality of vehicles and which the passenger has actually boarded. The passenger thus pays the fare which corresponds to comfort that the passenger feels depending on a combination of the attribute of the passenger and the attribute of the vehicle that the passenger has actually boarded. Therefore, a level of satisfaction of the passenger is improved as compared with a case where a fare does not vary regardless of comfort even in a case where the passenger boards any vehicle.

(Supplementary Note 2)

A management apparatus including:
a setting means for setting a fare to be collected from a passenger, in accordance with a combination of an attribute of the passenger and an attribute of a vehicle which is included in a plurality of vehicles and which is to be used by the passenger;
a storage means for storing therein reservation information including information indicative of the attribute of the vehicle to be used by the passenger;
a detecting means for detecting the passenger in a vicinity of a doorway of at least any vehicle included in the plurality of vehicles;
an obtaining means for obtaining information indicative of an attribute of the at least any vehicle having the doorway in which the passenger has been detected; and
a determining means for determining whether or not the information which is indicative of the attribute of the at least any vehicle and which has been obtained by the obtaining means matches the information which is indicative of the attribute of the vehicle and which is included in the reservation information.

With the above configuration, a fare is set which corresponds to a combination of an attribute of a passenger and an attribute of a vehicle which is included in a plurality of vehicles and which the passenger is to board. The passenger thus pays the fare which corresponds to comfort that the passenger feels depending on a combination of the attribute of the passenger and the attribute of the reserved vehicle when actually boarding the vehicle. Therefore, a level of satisfaction of the passenger is improved as compared with a case where a fare does not vary regardless of comfort even in a case where the passenger boards any vehicle.

Further, with the above configuration, when a passenger actually boards a vehicle, it is determined whether or not an attribute of the vehicle which the passenger boards matches reservation information. Therefore, it can be more certainly expected that the passenger boards a vehicle having an attribute which matches the reservation information.

(Supplementary Note 3)

The management apparatus as described in Supplementary Note 1 or 2, wherein the detecting means detects the passenger by reading biometric information relating to the passenger.

With the above configuration, a passenger can board and alight from a vehicle by reading of biometric information at a doorway. Therefore, convenience is improved.

(Supplementary Note 4)

The management apparatus as described in Supplementary Note 1 or 2, wherein the detecting means detects the passenger by reading information stored in a storage medium carried by the passenger.

With the above configuration, a passenger can board and alight from a vehicle by reading from a storage medium at a doorway. Therefore, convenience is improved.

(Supplementary Note 5)

The management apparatus as described in any one of Supplementary notes 1 through 4, wherein the setting means sets the fare by applying, to a normal fare which is determined with respect to a section in which the passenger boards the at least any vehicle/the vehicle, a discount which corresponds to the combination of the attribute of the passenger and the attribute of the at least any vehicle/the vehicle.

With the above configuration, a passenger pays a fare which is discounted in accordance with comfort that the passenger feels depending on a combination of an attribute of the passenger and an attribute of a vehicle. Therefore, passengers are expected to board a plurality of different vehicles, and congestion is reduced.

(Supplementary Note 6)

The management apparatus as described in any one of Supplementary notes 1 through 5, further including
a providing means for providing, in the at least any vehicle, a service which corresponds to the attribute of the at least any vehicle.

With the above configuration, by a passenger boarding a vehicle having an attribute which is suitable for an attribute of the passenger, the passenger can receive a service which corresponds to the attribute of the vehicle. As a result, a level of satisfaction is improved.

(Supplementary Note 7)

A management system including:
the management apparatus described in any one of Supplementary notes 1 through 6; and
a detection apparatus which is provided in the vicinity of the doorway of the at least any vehicle included in the plurality of vehicles and which detects the passenger,
the detecting means detecting the passenger with use of the detection apparatus.

With the above configuration, effects similar to those brought about by Supplementary Note 1 are brought about.

(Supplementary Note 8)

A method including:
detecting a passenger in a vicinity of a doorway of at least any vehicle included in a plurality of vehicles;
obtaining (i) information indicative of an attribute of the passenger who has been detected and (ii) information indicative of an attribute of the at least any vehicle having the doorway in which the passenger has been detected; and
setting a fare to be collected from the passenger, in accordance with a combination of the attribute of the passenger and the attribute of the at least any vehicle.

With the above configuration, effects similar to those brought about by Supplementary Note 1 are brought about.

(Supplementary Note 9)

A method including:
setting a fare to be collected from a passenger, in accordance with a combination of an attribute of the passenger and an attribute of a vehicle which is included in a plurality of vehicles and which is to be used by the passenger;
storing reservation information including information indicative of the attribute of the vehicle to be used by the passenger;
detecting the passenger in a vicinity of a doorway of at least any vehicle included in the plurality of vehicles;
obtaining information indicative of an attribute of the at least any vehicle having the doorway in which the passenger has been detected; and
determining whether or not the information which is indicative of the attribute of the at least any vehicle having the doorway in which the passenger has been detected matches the information which is indicative of the attribute of the vehicle and which is included in the reservation information.

With the above configuration, effects similar to those brought about by Supplementary Note 2 are brought about.

(Supplementary Note 10)

A program for causing a computer to function as a management apparatus, the program causing the computer to function as:
a detecting means for detecting a passenger in a vicinity of a doorway of at least any vehicle included in a plurality of vehicles;
an obtaining means for obtaining (i) information indicative of an attribute of the passenger who has been detected by the detecting means and (ii) information indicative of an attribute of the at least any vehicle having the doorway in which the passenger has been detected; and
a setting means for setting a fare to be collected from the passenger, in accordance with a combination of the attribute of the passenger and the attribute of the at least any vehicle.

With the above configuration, effects similar to those brought about by Supplementary Note 1 are brought about.

(Supplementary Note 11)

A program for causing a computer to function as a management apparatus, the program causing the computer to function as:
a setting means for setting a fare to be collected from a passenger, in accordance with a combination of an attribute of the passenger and an attribute of a vehicle which is included in a plurality of vehicles and which is to be used by the passenger;
a storage means for storing therein reservation information including information indicative of the attribute of the vehicle to be used by the passenger;
a detecting means for detecting the passenger in a vicinity of a doorway of at least any vehicle included in the plurality of vehicles;
an obtaining means for obtaining information indicative of an attribute of the at least any vehicle having the doorway in which the passenger has been detected; and
a determining means for determining whether or not the information which is indicative of the attribute of the at least any vehicle and which has been obtained by the obtaining means matches the information which is indicative of the attribute of the vehicle and which is included in the reservation information.

With the above configuration, effects similar to those brought about by Supplementary Note 2 are brought about.

[Additional Remark 3]

The whole or part of the example embodiments disclosed above can also be expressed as follows.

(Supplementary Note 12)

A management apparatus including at least one processor, the at least one processor carrying out:
a detecting process of detecting a passenger in a vicinity of a doorway of at least any vehicle included in a plurality of vehicles;
an obtaining process of obtaining (i) information indicative of an attribute of the passenger who has been detected in the detecting process and (ii) information indicative of an attribute of the at least any vehicle having the doorway in which the passenger has been detected; and
a setting process of setting a fare to be collected from the passenger, in accordance with a combination of the attribute of the passenger and the attribute of the at least any vehicle.

Note that the management apparatus as described in Supplementary Note 12 may further include a memory, and, in this memory, a program may be stored which is for causing the at least one processor to carry out the detecting process, the obtaining process, and the setting process. Alternatively, this program may be recorded in a computer-readable non-transitory tangible recording medium.

(Supplementary Note 13)

A management apparatus including at least one processor, the at least one processor the at least one processor carrying out:
a setting process of setting a fare to be collected from a passenger, in accordance with a combination of an attribute of the passenger and an attribute of a vehicle which is included in a plurality of vehicles and which is to be used by the passenger;
a storing process of storing reservation information including information indicative of the attribute of the vehicle to be used by the passenger;
a detecting process of detecting the passenger in a vicinity of a doorway of at least any vehicle included in the plurality of vehicles;
an obtaining process of obtaining information indicative of an attribute of the at least any vehicle having the doorway in which the passenger has been detected; and
a determining process of determining whether or not the information which is indicative of the attribute of the at least any vehicle and which has been obtained by the obtaining means matches the information which is indicative of the attribute of the vehicle and which is included in the reservation information.

Note that the management apparatus as described in Supplementary Note 13 may further include a memory, and, in this memory, a program may be stored which is for causing the at least one processor to carry out the setting process, the storing process, the detecting process, the obtaining process, and the determining process. Alternatively, this program may be recorded in a computer-readable non-transitory tangible recording medium.

### REFERENCE SIGNS LIST

1A, 1B, 2, 3, 4 Management system
100A, 100B Management apparatus
20, 30, 40, 60 Vehicle-mounted apparatus
30, 50 Management server
11A, 11B, 211, 311, 511 Obtaining section
12A, 12B, 212, 312, 512 Setting section
13A, 13B, 213, 413, 613 Detecting section
14B, 316, 516 Determining section
15B, 93, 250, 350, 450, 550, 650 Storage section
210, 310, 410, 510, 610 Control section
214, 414, 614 Providing section
221, 222, 422, 622 Boarding and alighting information generating section
221, 421, 621 Stop managing section
317, 517 Registering section
318, 518 Payment section
318, 319, 519 Recognizing section
330, 430, 530, 630 Communication section
415, 615 Opening and closing control section
71, 73 Terminal
72, 85 Camera
74, 83 Reader/writer
80 Vehicle
90 IC tag
200 Detection apparatus
C1 Processor
C2 Memory
N1 Network

What is claimed is:

1. A management apparatus comprising
at least one processor,
the at least one processor carrying out:
a detecting process of detecting a passenger in a vicinity of a doorway of at least any vehicle included in a plurality of vehicles;
an obtaining process of obtaining (i) information indicative of an attribute of the passenger who has been detected in the detecting process and (ii) information indicative of an attribute of the at least any vehicle having the doorway in which the passenger has been detected; and
a setting process of setting a fare to be collected from the passenger, in accordance with a combination of the attribute of the passenger and the attribute of the at least any vehicle.

2. A management apparatus comprising
at least one processor,
the at least one processor carrying out:
a setting process of setting a fare to be collected from a passenger, in accordance with a combination of an attribute of the passenger and an attribute of a vehicle which is included in a plurality of vehicles and which is to be used by the passenger;
a storage process of storing therein reservation information including information indicative of the attribute of the vehicle to be used by the passenger;
a detecting process of detecting the passenger in a vicinity of a doorway of at least any vehicle included in the plurality of vehicles;
an obtaining process of obtaining information indicative of an attribute of the at least any vehicle having the doorway in which the passenger has been detected; and
a determining process of determining whether or not the information which is indicative of the attribute of the at least any vehicle and which has been obtained in the obtaining process matches the information which is indicative of the attribute of the vehicle and which is included in the reservation information.

3. The management apparatus as set forth in claim 2, wherein in the detecting process, the at least one processor detects the passenger by reading biometric information relating to the passenger.

4. The management apparatus as set forth in claim 2, wherein in the detecting process, the at least one processor detects the passenger by reading information stored in a storage medium carried by the passenger.

5. The management apparatus as set forth in claim 2, wherein in the setting process, the at least one processor sets the fare by applying, to a normal fare which is determined with respect to a section in which the passenger boards the vehicle, a discount which corresponds to the combination of the attribute of the passenger and the attribute of the vehicle.

6. The management apparatus as set forth in claim 2, wherein the at least one processor further carries out
a providing process of providing, in the at least any vehicle, a service which corresponds to the attribute of the at least any vehicle.

7. A management system comprising:
the management apparatus recited in claim 2, and
a detection apparatus which is provided in the vicinity of the doorway of the at least any vehicle included in the plurality of vehicles and which detects the passenger,
in the detecting process, the at least one processor detecting the passenger with use of the detection apparatus.

8. (canceled)

9. A method comprising:
(a) setting a fare to be collected from a passenger, in accordance with a combination of an attribute of the passenger and an attribute of a vehicle which is included in a plurality of vehicles and which is to be used by the passenger;
(b) storing reservation information including information indicative of the attribute of the vehicle to be used by the passenger;
(c) detecting the passenger in a vicinity of a doorway of at least any vehicle included in the plurality of vehicles;
(d) obtaining information indicative of an attribute of the at least any vehicle having the doorway in which the passenger has been detected; and
(e) determining whether or not the information which is indicative of the attribute of the at least any vehicle having the doorway in which the passenger has been detected matches the information which is indicative of the attribute of the vehicle and which is included in the reservation information,
(a) through (e) being carried out by at least one processor.

10. A non-transitory recording medium in which a program for causing a computer to function as the management apparatus recited in claim 1 is recorded, the program causing the computer to carry out the detecting process, the obtaining process, and the setting process.

11. A non-transitory recording medium in which a program for causing a computer to function as the management apparatus recited in claim 2 is recorded, the program causing the computer to carry out the setting process, the storage process, the detecting process, the obtaining process, and the determining process.
